(19) United States
(12) Patent Application Publication
(10) Pub. No.: US 2026/0292176 A1
(43) Pub. Date: Sep. 24, 2026

(54) METHOD FOR CONDITIONING AN INTRA FRAME CODEC ON ITSELF IN AN END-TO-END LEARNED CODEC

(71) Applicant: Nokia Technologies Oy, Espoo (FI)

(72) Inventors: Nannan ZOU, Tampere (FI); Francesco CRICRÌ, Tampere (FI); Honglei ZHANG, Tampere (FI)

(21) Appl. No.: 19/474,093

(22) PCT Filed: Mar. 12, 2024
(86) PCT No.: PCT/EP2024/056516

§ 371 Date: Oct. 9, 2025

Related U.S. Application Data
(60) Provisional application No. 63/497,183, filed on Apr. 19, 2023.

(51) Int. Cl. H04N 19/124; H04N 19/91

(52) U.S. Cl. CPC H04N 19/124; H04N 19/91

(57) ABSTRACT

A method, apparatus, and computer program product are provided. In the context of a method, the method receives, by a first codec, ground-truth data. The method, based on the ground-truth data, generates a first bitstream. The method, based on the first bitstream, generates initial reconstruction data, wherein the initial reconstruction data comprises a reconstruction of the ground-truth data. The method outputs, by the first codec, the initial reconstruction data. The method determines residual ground-truth data based at least on the initial reconstruction data and the ground-truth data. The method determines auxiliary data based at least on the first bitstream or based at least on data derived from the first bitstream. The method receives, by a second codec, the residual ground-truth data and the auxiliary data. The method, based on the residual ground-truth data and the auxiliary data, generates a second bitstream.

### TECHNOLOGICAL FIELD

An example embodiment relates to video and image coder-decoders (codecs) and, more particularly, to end-to-end learned coder-decoders.

### BACKGROUND

Neural networks (NN) are utilized in an ever-increasing number of applications for a variety of devices, such as mobile phones. Neural networks are used for image and video analysis and processing, social media data analysis, device usage analysis, and other applications. Neural networks are computation graphs that consist of several layers of computation. Each layer may consist of one or more units that perform elementary computations. A unit is connected to one or more other units, and the connection is often associated with a weight used for scaling a signal passing through the connection. The weight is a value which can be learned from training data. In addition, batch-normalization layer parameters can be learned from training data.

Feed-forward neural networks have no feedback loops, with each layer receiving input from the layer before and providing its output to the next layer. Initial layers close to the input data extract semantically low-level features such as edges and textures in images, while intermediate and final layers extract more high-level features. In addition, one or more layers may perform tasks such as classification, semantic segmentation, object detection, denoising, style transfer, super-resolution, and/or the like. Recurrent neural networks have a feedback loop, causing the neural network to become stateful. Recurrent neural networks are able to memorize information or a state.

Neural networks are able to learn properties from input data in a supervised or unsupervised manner. This ability comes as a result of a training algorithm or a meta-level neural network providing a training signal. A training algorithm alters properties of a neural network so that an output is as close as possible to a desired output. For example, for a neural network classifying objects in images, the neural network output can be used to derive a class or category index for the objects. Training minimizes or decreases the output's error, referred to as loss. Examples of losses include mean squared error and cross-entropy. Training can be an iterative process where at each iteration an algorithm modifies the weights of the neural network to gradually decrease the network's loss. The final goal of training the neural network is to make the neural network learn the properties of the data distribution from a limited training dataset, or to “generalize” data which was not used for training the neural network. A validation data set that was not used for training is often used to check the performance of the neural network.

When checking the performance of a neural network, the training set error should decrease. Otherwise, the neural network is in the regime of underfitting. If the neural network is working to generalize, the validation set error should decrease and should not be too much higher than the training set error. Otherwise, the neural network is in the regime of overfitting (i.e., the neural network has memorized the training set's properties and performs well only on that set).

Neural network based codecs may be used for compressing and de-compressing data such as images in the case of image codecs. Neural network based Image codecs may comprise a component called an auto-encoder, which comprises a neural encoder and a neural decoder. A neural encoder takes an image as input and produces a latent tensor which may require less bits than the input image. The latent tensor may be quantized and lossless compressed, to obtain a bitstream that represents the encoded image. A neural decoder takes the bitstream and reconstructs the image which was input into the neural encoder.

Neural encoders and decoders are trained to minimize a combination of bitrate and distortion. Distortion may be based on Mean Squared Error (MSE), Peak Signal-to-Noise Ratio (PSNR), Structural Similarity Index Measure (SSIM), or the like. These distortion metrics are correlated to human visual perception quality, such that improving them improves the visual quality of a decoded image as perceived by humans.

A video codec includes a neural encoder that transforms an input video into a compressed representation suited for storage/transmission and a neural decoder that decompresses the compressed video representation back into a viewable form. A neural encoder typically discards some information in the original video in order to represent the video in a more compact form (at a lower bitrate). A hybrid video codec may encode video information in two phases. First, pixel values for a certain picture block are predicted. For example, pixel values may be predicted by motion compensation means (i.e., finding and indicating an area in one of the previously coded video frames that corresponds closely to the block being coded) or by spatial means (i.e., using the pixel values around the block to be coded in a specified manner). Second, the prediction error (i.e., the difference between the predicted block of pixels and the original block of pixels) is coded. For example, this may be done by transforming the difference in pixel values using a specified transform (e.g., Discrete Cosine Transform), quantizing the coefficients, and entropy coding the quantized coefficients. By varying the fidelity of the quantization process, the neural encoder controls a balance between the accuracy of the pixel presentation (pixel quality) and the size of the resulting coded video representation (file size or transmission bitrate).

Inter prediction (also known as temporal prediction, motion compensation, or motion-compensated prediction) exploits temporal redundancy. Inter prediction uses previously decoded pictures as the sources of prediction. In contrast, intra prediction uses adjacent pixels within the same two pictures. Intra prediction can be performed in the spatial domain to predict sample values or the transform domain to predict transform coefficients. Intra prediction is often exploited in intra coding, where no prediction is applied.

On outcome of the coding procedure is a set of coding parameters, such as motion vectors and quantized transform coefficients. Parameters may be entropy-coded more efficiently if they are fist predicted from spatially or temporally neighboring parameters. For example, a motion vector may be predicted from spatially adjacent motion vectors, and only the difference relative to the motion vector predictor may be coded. Predictions of coding parameters and intra prediction may be collectively referred to as in-picture prediction.

A decoder reconstructs a video input to the encoder by applying prediction means similar to the encoder. By doing this, the decoder forms a predicted representation of the pixel blocks using the motion or spatial information created by the encoder and stored in the compressed representation. The decoder performs prediction error decoding (the inverse operation of the prediction error coding which recovers the quantized prediction error signal in a spatial pixel domain). After applying prediction and prediction error decoding, the decoder sums up the prediction and prediction error signals (pixel values) to form the output video frame. The decoder and encoder can also apply additional filtering to improve the quality of the output video before passing it for display pr storing it as a prediction reference for forthcoming frames in the video sequence.

In typical video coder-decoders, motion information is indicated with motion vectors associated with each motion compensated image block. Each motion vector represents the displacement of the respective image block in the picture to be coded or decoded and the prediction source block in one of the previously coded or decoded pictures. In order to represent motion vectors efficiently, they are typically coded differentially with respect to block specific predicted motion vectors. In typical video codecs, the predicted motion vectors are created in a predefined way. For example, they may be created by calculating the median of the encoded or decoded motion vectors of the adjacent blocks. Another method of creating motion vector predictions is by generating a list of candidate predictions from adjacent blocks and/or co-located blocks in temporal reference pictures and signaling a chosen candidate as the motion vector predictor. In addition, the reference index of a previously coded or decoded picture can be predicted. The reference index may be predicted from adjacent blocks and/or co-located blocks in a temporal reference picture. Moreover, typical high efficiency video codecs employ an additional motion information coding/decoding mechanism. This mechanism is often called merge mode, where all motion field information) including the motion vector and the corresponding reference picture index for each available reference picture list) is predicted and used without modification or correction. Similarly, predicting the motion field information is carried out by using the motion field information of adjacent blocks and/or co-located blocks in temporal reference pictures. The used motion field information is signaled among a list of motion field candidates with motion field information of available adjacent and/or co-located blocks.

In typical video codecs, the prediction residual after motion compensation is first transformed with a transform kernel such as DCT and then coded. This is done to reduce the correlation among the prediction residual and provide more efficient coding. Typical video encoders use Lagrangian cost functions to find optimal coding modes (e.g., the desired Macroblock mode and associated motion vectors). This is a costly function that uses a weighting factor λ to tie together the image distortion due to lossy coding methods and the amount of information that is required to represent the pixel values in an image area. The cost can be represented by the equation C=D+λ, where C is the Lagrangian cost to be minimized, D is the image distortion (such as Mean Squared Error) with the mode and motion vectors considered, and R is the number of bits needed to represent the required data for reconstructing the image block in the decoder (including the amount of data to represent the candidate motion vectors).

In some circumstances, supplemental enhancement information (SEI) messages may be used. In some circumstances, SEI NAL units including prefix SEI NAL units and suffix SEI NAL units are used. Prefix SEI NAL units are able to start a picture unit and suffix SEI NAL units are able to end a picture unit. An SEI unit contains one or more SEI messages, which are not required for the decoding of output pictures but may assist in related processes such as picture output timing, post-processing of decoded pictures, rendering, error detection, error concealment, and resource reservation.

Image and video codecs may use a set of filters to enhance the visual quality of the predicted visual content. These filters can be applied in-loop, out-of-loop, or both. In the case of in-loop filters, a filter applied on one block in a currently-encoded frame will affect the encoding of another block in the same frame and/or in another frame which was predicted from the currently-encoded frame. An in-loop filter may affect the bitrate and/or the visual quality. An enhanced block will cause a smaller residual (the difference between the original block and the predicted and filtered block), therefore requiring less bits to be encoded. An out-of-the-loop filter will be applied on a frame after it has been reconstructed. In this circumstance, the filtered visual content won't be a source for prediction and may only impact the visual quality of frames that are output by the decoder.

Embodiments herein disclose improved video and image codecs, improving rate distortion performance of video and image compression using an end-to-end learned codec. Embodiments of the present disclosure provide lower bitrate and higher PSNR of luma for a resulting reconstructed image than previous embodiments. Embodiments of the present disclosure achieve a better rate-distortion performance in a reconstructed image.

### BRIEF SUMMARY

A method, apparatus, and computer program product are disclosed for an end-to-end learned intra frame codec. By using end-to-end learning with multiple codecs, bitrate is reduced and PSNR is improved.

In an example embodiment, a method is provided that comprises receiving, by a first codec, ground-truth data. The method further comprises, based on the ground-truth data, generating a first bitstream. The method further comprises, based on the first bitstream, generating initial reconstruction data, wherein the initial reconstruction data comprises a reconstruction of the ground-truth data. The method further comprises outputting, by the first codec, the initial reconstruction data. The method further comprises determining residual ground-truth data based at least on the initial reconstruction data and the ground-truth data. The method further comprises determining auxiliary data based at least on the first bitstream or based at least on data derived from the first bitstream. The method further comprises receiving, by a second codec, the residual ground-truth data and the auxiliary data. The method further comprises, based on the residual ground-truth data and the auxiliary data, generating a second bitstream.

The method of an example embodiment further comprises, based on the second bitstream, generating residual reconstruction data, wherein the residual reconstruction data comprises a reconstruction of the residual ground-truth data. The method further comprises outputting, by the second codec, the residual reconstruction data.

The method of an example embodiment further comprises determining combined reconstruction data based at least on the initial reconstruction data and the residual reconstruction data.

The method of an example embodiment further comprises determining a combined bitstream based at least on the first bitstream and the second bitstream.

In an example embodiment, the residual ground-truth data comprises a difference between the ground-truth data and the initial reconstruction data.

In an example embodiment, the ground-truth data comprises an image comprising brightness data and color data.

The method of an example embodiment further comprises converting, using a first neural encoder, the ground-truth data into a first latent tensor. The method further comprises generating, using a first quantizer and a first predefined set of quantization levels, a first quantized latent tensor based at least on the first latent tensor, wherein the first quantized latent tensor comprises at least one symbol or element. The method further comprises, for a respective symbol or element of the at least one symbol or element of the first quantized latent tensor, determining, using a first probability model, a first estimated probability distribution of possible values. The method further comprises encoding, using a first entropy encoder, the respective symbol or element of the at least one symbol or element of the first quantized latent tensor into the first bitstream based at least on the first estimated probability distribution of possible values.

The method of an example embodiment further comprises decoding, using a first entropy decoder and the first probability model or a copy of the first probability model, the first bitstream into the first quantized latent tensor or a quantized latent tensor that is the same as the first quantized latent tensor. The method further comprises generating, using a first dequantizer, a first resulting latent tensor. The method further comprises converting, using a first neural decoder, the first resulting latent tensor into the initial reconstruction data.

The method of an example embodiment further comprises converting, using a second neural encoder, the residual ground-truth data into a second latent tensor. The method further comprises generating, using a second quantizer and a second predefined set of quantization levels, a second quantized latent tensor based at least on the second latent tensor, wherein the second quantized latent tensor comprises at least one symbol or element. The method further comprises converting, using an auxiliary encoder, the auxiliary data into auxiliary features. The method further comprises inputting the auxiliary features into a second probability model. The method further comprises, for a respective symbol or element of the at least one symbol or element of the second quantized latent tensor, determining, using the second probability model, a second estimated probability distribution of possible values. The method further comprises encoding, using a second entropy encoder, the respective symbol or element of the at least one symbol or element of the second quantized latent tensor into the second bitstream based at least on the second estimated probability distribution of possible values.

The method of an example embodiment further comprises decoding, using a second entropy decoder, the auxiliary encoder or another auxiliary encoder that is the same as the auxiliary encoder, and the second probability model or another probability model that is the same as the second probability model, the second bitstream into the second quantized latent tensor or a quantized latent tensor that is the same as the second quantized latent tensor. The method further comprises generating, using a second dequantizer, a second resulting latent tensor. The method further comprises converting, using a second neural decoder, the second resulting latent tensor into the residual reconstruction data.

In an example embodiment, at least one of the first neural encoder, the first neural decoder, the first probability model, the second neural encoder, the second neural decoder, the second probability model, and the auxiliary encoder comprise neural network components.

In an example embodiment, the first codec and the second codec are trained in an end-to-end manner by decreasing at least one of distortion loss and rate loss.

In an example embodiment, the first codec is trained before the second codec, and wherein the second codec is trained based at least on the first codec or based at least on data that is generated by the first codec.

In an example embodiment, the first codec and the second codec are trained simultaneously.

In an example embodiment, the first codec and the second codec are trained at alternating intervals.

In an example embodiment, the auxiliary data comprises one or more of the initial reconstruction data, the first latent tensor, and first resulting latent tensor.

In an example embodiment, the residual ground-truth data is determined by the first codec.

In an example embodiment, the combined reconstruction data is determined by the second codec.

The method of an example embodiment further comprises determining additional residual ground-truth data, based at least on the combined reconstruction data and the ground-truth data. The method further comprises determining additional auxiliary data based at least on the second bitstream or based at least on data derived from the second bitstream. The method further comprises receiving, by a different codec, the additional residual ground-truth data and the additional auxiliary data. The method further comprises, based at least on the additional residual ground-truth data and the additional auxiliary data, generating an additional bitstream. The method further comprises, based on the additional bitstream, generating additional reconstruction data, wherein the additional reconstruction data comprises a reconstruction of the additional residual ground-truth data, and wherein the additional reconstruction data is operable to combine with the combined reconstruction data to form compounded reconstruction data. The method further comprises outputting, by the different codec, at least one of the additional reconstruction data and the compounded reconstruction data.

In an example embodiment, a method is provided that comprises receiving a first bitstream. The method further comprises, based on the first bitstream, generating initial reconstruction data. The method further comprises determining auxiliary data based at least on the first bitstream or based at least on data derived from the first bitstream. The method further comprises outputting the initial reconstruction data. The method further comprises receiving a second bitstream. The method further comprises, based on the second bitstream and the auxiliary data, generating residual reconstruction data. The method further comprises outputting the residual reconstruction data

The method of an example embodiment further comprises determining combined reconstruction data based at least on the initial reconstruction data and the residual reconstruction data.

In an example embodiment, the first bitstream and the second bitstream are received as parts of a combined bitstream.

The method of an example embodiment further comprises decoding, using a first entropy decoder and a first probability model, the first bitstream into a first quantized latent tensor. The method further comprises generating, using a first dequantizer and based on the first quantized latent tensor, a first latent tensor. The method further comprises converting, using a first neural decoder, the first latent tensor into the initial reconstruction data.

The method of an example embodiment further comprises decoding, using a second entropy decoder, an auxiliary encoder, and a second probability model, the second bitstream into a second quantized latent tensor. The method further comprises generating, using a second dequantizer and based on the second quantized latent tensor, a second latent tensor. The method further comprises converting, using a second neural decoder, the second latent tensor into the residual reconstruction data.

In an example embodiment, at least one of the first neural decoder, the first probability model, the second neural decoder, and the second probability model comprise neural network components.

The method of an example embodiment further comprises receiving an additional bitstream. The method further comprises, based on the additional bitstream, generating additional reconstruction data, wherein the additional reconstruction data is operable to combine with the combined reconstruction data to form compounded reconstruction data. The method further comprises outputting at least one of the additional reconstruction data and the compounded reconstruction data.

In an example embodiment, an apparatus is provided that comprises at least one processor and at least one memory including computer program code configured to, with the at least one processor, cause the apparatus to receive, by a first codec, ground-truth data. The at least one memory and the computer program code are further configured to, based on the ground-truth data, generate a first bitstream. The at least one memory and the computer program code are further configured to, based on the first bitstream, generate initial reconstruction data, wherein the initial reconstruction data comprises a reconstruction of the ground-truth data. The at least one memory and the computer program code are further configured to output, by the first codec, the initial reconstruction data. The at least one memory and the computer program code are further configured to determine residual ground-truth data based at least on the initial reconstruction data and the ground-truth data. The at least one memory and the computer program code are further configured to determine auxiliary data based at least on first bitstream or based at least on data derived from the first bitstream. The at least one memory and the computer program code are further configured to receive, by a second codec, the residual ground-truth data and the auxiliary data. The at least one memory and the computer program code are further configured to, based on the residual ground-truth data and the auxiliary data, generate a second bitstream.

In an example embodiment, the at least one memory and the computer program code are further configured to, with the at least one processor, cause the apparatus to, based on the second bitstream, generate residual reconstruction data, wherein the residual reconstruction data comprises a reconstruction of the residual ground-truth data. The at least one memory and the computer program code are further configured to output, by the second codec, the residual reconstruction data.

In an example embodiment, the at least one memory and the computer program code are further configured to, with the at least one processor, cause the apparatus to determine combined reconstruction data based at least on the initial reconstruction data and the residual reconstruction data.

In an example embodiment, the at least one memory and the computer program code are further configured to, with the at least one processor, cause the apparatus to determine a combined bitstream based at least on the first bitstream and the second bitstream.

In an example embodiment, the residual ground-truth data comprises a difference between the ground-truth data and the initial reconstruction data.

In an example embodiment, the ground-truth data comprises an image comprising brightness data and color data.

In an example embodiment, the at least one memory and the computer program code are further configured to, with the at least one processor, cause the apparatus to convert, using a first neural encoder, the ground-truth data into a first latent tensor. The at least one memory and the computer program code are further configured to generate, using a first quantizer and a first predefined set of quantization levels, a first quantized latent tensor based at least on the first latent tensor, wherein the first quantized latent tensor comprises at least one symbol or element. The at least one memory and the computer program code are further configured to, for a respective symbol or element of the at least one symbol or element of the first quantized latent tensor, determine, using a first probability model, a first estimated probability distribution of possible values. The at least one memory and the computer program code are further configured to encode, using a first entropy encoder, the respective symbol or element of the at least one symbol or element of the first quantized latent tensor into the first bitstream based at least on the first estimated probability distribution of possible values.

In an example embodiment, the at least one memory and the computer program code are further configured to, with the at least one processor, cause the apparatus to decode, using a first entropy decoder and the first probability model or a copy of the first probability model, the first bitstream into the first quantized latent tensor or a quantized latent tensor that is the same as the first quantized latent tensor. The at least one memory and the computer program code are further configured to generate, using a first dequantizer, a first resulting latent tensor. The at least one memory and the computer program code are further configured to convert, using a first neural decoder, the first resulting latent tensor into the initial reconstruction data.

In an example embodiment, the at least one memory and the computer program code are further configured to, with the at least one processor, cause the apparatus to convert, using a second neural encoder, the residual ground-truth data into a second latent tensor. The at least one memory and the computer program code are further configured to generate, using a second quantizer and a second predefined set of quantization levels, a second quantized latent tensor based at least on the second latent tensor, wherein the second quantized latent tensor comprises at least one symbol or element. The at least one memory and the computer program code are further configured to convert, using an auxiliary encoder, the auxiliary data into auxiliary features. The at least one memory and the computer program code are further configured to input the auxiliary features into a second probability model. The at least one memory and the computer program code are further configured to, for a respective symbol or element of the at least one symbol or element of the second quantized latent tensor, determine, using the second probability model, a second estimated probability distribution of possible values. The at least one memory and the computer program code are further configured to encode, using a second entropy encoder, the respective symbol or element of the at least one symbol or element of the second quantized latent tensor into the second bitstream based at least on the second estimated probability distribution of possible values.

In an example embodiment, the at least one memory and the computer program code are further configured to, with the at least one processor, cause the apparatus to decode, using a second entropy decoder, the auxiliary encoder, and the second probability model or a copy of the second probability model, the second bitstream into the second quantized latent tensor or a quantized latent tensor that is the same as the second quantized latent tensor. The at least one memory and the computer program code are further configured to generate, using a second dequantizer, a second resulting latent tensor. The at least one memory and the computer program code are further configured to convert, using a second neural decoder, the second resulting latent tensor into the residual reconstruction data.

In an example embodiment, at least one of the first neural encoder, the first neural decoder, the first probability model, the second neural encoder, the second neural decoder, the second probability model, and the auxiliary encoder comprise neural network components.

In an example embodiment, the first codec and the second codec are trained in an end-to-end manner by decreasing at least one of distortion loss and rate loss.

In an example embodiment, the first codec is trained before the second codec, and wherein the second codec is trained based at least on the first codec or based at least on data that is generated by the first codec.

In an example embodiment, the first codec and the second codec are trained simultaneously.

In an example embodiment, the first codec and the second codec are trained at alternating intervals.

In an example embodiment, the auxiliary data comprises one or more of the initial reconstruction data, the first latent tensor, and the first resulting latent tensor.

In an example embodiment, the residual ground-truth data is determined by the first codec.

In an example embodiment, the combined reconstruction data is determined by the second codec.

In an example embodiment, the at least one memory and the computer program code are further configured to, with the at least one processor, cause the apparatus to determine additional residual ground-truth data, based at least on the combined reconstruction data and the ground-truth data. The at least one memory and the computer program code are further configured to determine additional auxiliary data based at least on the second bitstream or based at least on data derived from the second bitstream. The at least one memory and the computer program code are further configured to receive, by a different codec, the additional residual ground-truth data and the additional auxiliary data. The at least one memory and the computer program code are further configured to, based at least on the additional residual ground-truth data and the additional auxiliary data, generate an additional bitstream. The at least one memory and the computer program code are further configured to, based on the additional bitstream, generate additional reconstruction data, wherein the additional reconstruction data comprises a reconstruction of the additional residual ground-truth data, and wherein the additional reconstruction data is operable to combine with the combined reconstruction data to form compounded reconstruction data. The at least one memory and the computer program code are further configured to output, by the different codec, the additional reconstruction data.

In an example embodiment, an apparatus is provided that comprises at least one processor and at least one memory including computer program code configured to, with the at least one processor, cause the apparatus to receive a first bitstream. The at least one memory and the computer program code are further configured to, based on the first bitstream, generate initial reconstruction data. The at least one memory and the computer program code are further configured to determine auxiliary data based at least on the first bitstream or based at least on data derived from the first bitstream. The at least one memory and the computer program code are further configured to output the initial reconstruction data. The at least one memory and the computer program code are further configured to receive a second bitstream. The at least one memory and the computer program code are further configured to, based on the second bitstream and the auxiliary data, generate residual reconstruction data. The at least one memory and the computer program code are further configured to output the residual reconstruction data.

In an example embodiment, the at least one memory and the computer program code are further configured to, with the at least one processor, cause the apparatus to determine combined reconstruction data based at least on the initial reconstruction data and the residual reconstruction data.

In an example embodiment, the first bitstream and the second bitstream are received as parts of a combined bitstream.

In an example embodiment, the at least one memory and the computer program code are further configured to, with the at least one processor, cause the apparatus to decode, using a first entropy decoder and a first probability model, the first bitstream into a first quantized latent tensor. The at least one memory and the computer program code are further configured to generate, using a first dequantizer and based on the first quantized latent tensor, a first latent tensor. The at least one memory and the computer program code are further configured to convert, using a first neural decoder, the first latent tensor into the initial reconstruction data.

In an example embodiment, the at least one memory and the computer program code are further configured to, with the at least one processor, cause the apparatus to decode, using a second entropy decoder, an auxiliary encoder, and a second probability model, the second bitstream into a second quantized latent tensor. The at least one memory and the computer program code are further configured to generate, using a second dequantizer and based on the second quantized latent tensor, a second latent tensor. The at least one memory and the computer program code are further configured to convert, using a second neural decoder, the second latent tensor into the residual reconstruction data.

In an example embodiment, at least one of the first neural decoder, the first probability model, the second neural decoder, and the second probability model comprise neural network components.

In an example embodiment, at least one memory and the computer program code are further configured to, with the at least one processor, cause the apparatus to receive an additional bitstream. The at least one memory and the computer program code are further configured to, based on the additional bitstream, generate additional reconstruction data, wherein the additional reconstruction data is operable to combine with the combined reconstruction data to form compounded reconstruction data. The at least one memory and the computer program code are further configured to output the additional reconstruction data.

In an example embodiment, a non-transitory computer readable storage medium is provided comprising computer instructions that, when executed by an apparatus, cause the apparatus to receive, by a first codec, ground-truth data. The non-transitory computer readable storage medium further includes computer instructions configured, upon execution, to, based on the ground-truth data, generate a first bitstream. The non-transitory computer readable storage medium further includes computer instructions configured, upon execution, to, based on the first bitstream, generate initial reconstruction data, wherein the initial reconstruction data comprises a reconstruction of the ground-truth data. The non-transitory computer readable storage medium further includes computer instructions configured, upon execution, to output, by the first codec, the initial reconstruction data. The non-transitory computer readable storage medium further includes computer instructions configured, upon execution, to determine residual ground-truth data based at least on the initial reconstruction data and the ground-truth data. The non-transitory computer readable storage medium further includes computer instructions configured, upon execution, to determine auxiliary data based at least on first bitstream or based at least on data derived from the first bitstream. The non-transitory computer readable storage medium further includes computer instructions configured, upon execution, to receive, by a second codec, the residual ground-truth data and the auxiliary data. The non-transitory computer readable storage medium further includes computer instructions configured, upon execution, to, based on the residual ground-truth data and the auxiliary data, generate a second bitstream.

The non-transitory computer readable storage medium of an example embodiment further includes computer instructions configured, upon execution, to, based on the second bitstream, generate residual reconstruction data, wherein the residual reconstruction data comprises a reconstruction of the residual ground-truth data. The non-transitory computer readable storage medium further includes computer instructions configured, upon execution, to output, by the second codec, the residual reconstruction data.

The non-transitory computer readable storage medium of an example embodiment further includes computer instructions configured, upon execution, to determine combined reconstruction data based at least on the initial reconstruction data and the residual reconstruction data.

The non-transitory computer readable storage medium of an example embodiment further includes computer instructions configured, upon execution, to determine a combined bitstream based at least on the first bitstream and the second bitstream.

In an example embodiment, the residual ground-truth data comprises a difference between the ground-truth data and the initial reconstruction data.

In an example embodiment, the ground-truth data comprises an image comprising brightness data and color data.

The non-transitory computer readable storage medium of an example embodiment further includes computer instructions configured, upon execution, to convert, using a first neural encoder, the ground-truth data into a first latent tensor. The non-transitory computer readable storage medium further includes computer instructions configured, upon execution, to generate, using a first quantizer and a first predefined set of quantization levels, a first quantized latent tensor based at least on the first latent tensor, wherein the first quantized latent tensor comprises at least one symbol or element. The non-transitory computer readable storage medium further includes computer instructions configured, upon execution, to, for a respective symbol or element of the at least one symbol or element of the first quantized latent tensor, determine, using a first probability model, a first estimated probability distribution of possible values. The non-transitory computer readable storage medium further includes computer instructions configured, upon execution, to encode, using a first entropy encoder, the respective symbol or element of the at least one symbol or element of the first quantized latent tensor into the first bitstream based at least on the first estimated probability distribution of possible values.

The non-transitory computer readable storage medium of an example embodiment further includes computer instructions configured, upon execution, to decode, using a first entropy decoder and the first probability model or a copy of the first probability model, the first bitstream into the first quantized latent tensor or a quantized latent tensor that is the same as the first quantized latent tensor. The non-transitory computer readable storage medium further includes computer instructions configured, upon execution, to generate, using a first dequantizer, a first resulting latent tensor. The non-transitory computer readable storage medium further includes computer instructions configured, upon execution, to convert, using a first neural decoder, the first resulting latent tensor into the initial reconstruction data.

The non-transitory computer readable storage medium of an example embodiment further includes computer instructions configured, upon execution, to convert, using a second neural encoder, the residual ground-truth data into a second latent tensor. The non-transitory computer readable storage medium further includes computer instructions configured, upon execution, to generate, using a second quantizer and a second predefined set of quantization levels, a second quantized latent tensor based at least on the second latent tensor, wherein the second quantized latent tensor comprises at least one symbol or element. The non-transitory computer readable storage medium further includes computer instructions configured, upon execution, to convert, using an auxiliary encoder, the auxiliary data into auxiliary features. The non-transitory computer readable storage medium further includes computer instructions configured, upon execution, to input the auxiliary features into a second probability model. The non-transitory computer readable storage medium further includes computer instructions configured, upon execution, to, for a respective symbol or element of the at least one symbol or element of the second quantized latent tensor, determine, using the second probability model, a second estimated probability distribution of possible values. The non-transitory computer readable storage medium further includes computer instructions configured, upon execution, to encode, using a second entropy encoder, the respective symbol or element of the at least one symbol or element of the second quantized latent tensor into the second bitstream based at least on the second estimated probability distribution of possible values.

The non-transitory computer readable storage medium of an example embodiment further includes computer instructions configured, upon execution, to decode, using a second entropy decoder, the auxiliary encoder, and the second probability model or a copy of the second probability model, the second bitstream into the second quantized latent tensor or a quantized latent tensor that is the same as the second quantized latent tensor. The non-transitory computer readable storage medium further includes computer instructions configured, upon execution, to generate, using a second dequantizer, a second resulting latent tensor. The non-transitory computer readable storage medium further includes computer instructions configured, upon execution, to convert, using a second neural decoder, the second resulting latent tensor into the residual reconstruction data.

In an example embodiment, at least one of the first neural encoder, the first neural decoder, the first probability model, the second neural encoder, the second neural decoder, the second probability model, and the auxiliary encoder comprise neural network components.

In an example embodiment, the first codec and the second codec are trained in an end-to-end manner by decreasing at least one of distortion loss and rate loss.

In an example embodiment, the first codec is trained before the second codec, and wherein the second codec is trained based at least on the first codec or based at least on data that is generated by the first codec.

In an example embodiment, the first codec and the second codec are trained simultaneously.

In an example embodiment, the first codec and the second codec are trained at alternating intervals.

In an example embodiment, the auxiliary data comprises one or more of the initial reconstruction data, the first latent tensor, and the first resulting latent tensor.

In an example embodiment, the residual ground-truth data is determined by the first codec.

In an example embodiment, the combined reconstruction data is determined by the second codec.

The non-transitory computer readable storage medium of an example embodiment further includes computer instructions configured, upon execution, to determine additional residual ground-truth data, based at least on the combined reconstruction data and the ground-truth data. The non-transitory computer readable storage medium further includes computer instructions configured, upon execution, to determine additional auxiliary data based at least on the second bitstream or based at least on data derived from the second bitstream. The non-transitory computer readable storage medium further includes computer instructions configured, upon execution, to receive, by a different codec, the additional residual ground-truth data and the additional auxiliary data. The non-transitory computer readable storage medium further includes computer instructions configured, upon execution, to, based at least on the additional residual ground-truth data and the additional auxiliary data, generate an additional bitstream. The non-transitory computer readable storage medium further includes computer instructions configured, upon execution, to, based on the additional bitstream, generate additional reconstruction data, wherein the additional reconstruction data comprises a reconstruction of the additional residual ground-truth data, and wherein the additional reconstruction data is operable to combine with the combined reconstruction data to form compounded reconstruction data. The non-transitory computer readable storage medium further includes computer instructions configured, upon execution, to output, by the different codec, the additional reconstruction data.

In an example embodiment, a non-transitory computer readable storage medium is provided comprising computer instructions that, when executed by an apparatus, cause the apparatus to receive a first bitstream. The non-transitory computer readable storage medium further includes computer instructions configured, upon execution, to, based on the first bitstream, generate initial reconstruction data. The non-transitory computer readable storage medium further includes computer instructions configured, upon execution, to determine auxiliary data based at least on the first bitstream or based at least on data derived from the first bitstream. The non-transitory computer readable storage medium further includes computer instructions configured, upon execution, to output the initial reconstruction data. The non-transitory computer readable storage medium further includes computer instructions configured, upon execution, to receive a second bitstream. The non-transitory computer readable storage medium further includes computer instructions configured, upon execution, to, based on the second bitstream and the auxiliary data, generate residual reconstruction data. The non-transitory computer readable storage medium further includes computer instructions configured, upon execution, to output the residual reconstruction data.

The non-transitory computer readable storage medium of an example embodiment further includes computer instructions configured, upon execution, to determine combined reconstruction data based at least on the initial reconstruction data and the residual reconstruction data.

In an example embodiment, the first bitstream and the second bitstream are received as parts of a combined bitstream.

The non-transitory computer readable storage medium pf an example embodiment further includes computer instructions configured, upon execution, to decode, using a first entropy decoder and a first probability model, the first bitstream into a first quantized latent tensor. The non-transitory computer readable storage medium further includes computer instructions configured, upon execution, to generate, using a first dequantizer and based on the first quantized latent tensor, a first latent tensor. The non-transitory computer readable storage medium further includes computer instructions configured, upon execution, to convert, using a first neural decoder, the first latent tensor into the initial reconstruction data.

The non-transitory computer readable storage medium of an example embodiment further includes computer instructions configured, upon execution, to decode, using a second entropy decoder, an auxiliary encoder, and a second probability model, the second bitstream into a second quantized latent tensor. The non-transitory computer readable storage medium further includes computer instructions configured, upon execution, to generate, using a second dequantizer and based on the second quantized latent tensor, a second latent tensor. The non-transitory computer readable storage medium further includes computer instructions configured, upon execution, to convert, using a second neural decoder, the second latent tensor into the residual reconstruction data.

In an example embodiment, at least one of the first neural decoder, the first probability model, the second neural decoder, and the second probability model comprise neural network components.

The non-transitory computer readable storage medium of an example embodiment further includes computer instructions configured, upon execution, to receive an additional bitstream.

The non-transitory computer readable storage medium further includes computer instructions configured, upon execution, to, based on the additional bitstream, generate additional reconstruction data, wherein the additional reconstruction data is operable to combine with the combined reconstruction data to form compounded reconstruction data. The non-transitory computer readable storage medium further includes computer instructions configured, upon execution, to output the additional reconstruction data.

In an example embodiment, an apparatus is provided comprising means for receiving, by a first codec, ground-truth data. The apparatus further comprises means for, based on the ground-truth data, generating a first bitstream. The apparatus further comprises means for, based on the first bitstream, generating initial reconstruction data, wherein the initial reconstruction data comprises a reconstruction of the ground-truth data. The apparatus further comprises means for outputting, by the first codec, the initial reconstruction data. The apparatus further comprises means for determining residual ground-truth data based at least on the initial reconstruction data and the ground-truth data. The apparatus further comprises means for determining auxiliary data based at least on the first bitstream or based at least on data derived from the first bitstream. The apparatus further comprises means for receiving, by a second codec, the residual ground-truth data and the auxiliary data. The apparatus further comprises means for, based on the residual ground-truth data and the auxiliary data, generating a second bitstream.

The apparatus of an example embodiment further comprises means for, based on the second bitstream, generating residual reconstruction data, wherein the residual reconstruction data comprises a reconstruction of the residual ground-truth data. The apparatus further comprises means for outputting, by the second codec, the residual reconstruction data.

The apparatus of an example embodiment further comprises means for determining combined reconstruction data based at least on the initial reconstruction data and the residual reconstruction data.

The apparatus of an example embodiment further comprises means for determining a combined bitstream based at least on the first bitstream and the second bitstream.

In an example embodiment, the residual ground-truth data comprises a difference between the ground-truth data and the initial reconstruction data.

In an example embodiment, the ground-truth data comprises an image comprising brightness data and color data.

The apparatus of an example embodiment further comprises means for converting, using a first neural encoder, the ground-truth data into a first latent tensor. The apparatus further comprises means for generating, using a first quantizer and a first predefined set of quantization levels, a first quantized latent tensor based at least on the first latent tensor, wherein the first quantized latent tensor comprises at least one symbol or element. The apparatus further comprises means for, for a respective symbol or element of the at least one symbol or element of the first quantized latent tensor, determining, using a first probability model, a first estimated probability distribution of possible values. The apparatus further comprises means for encoding, using a first entropy encoder, the respective symbol or element of the at least one symbol or element of the first quantized latent tensor into the first bitstream based at least on the first estimated probability distribution of possible values.

The apparatus of an example embodiment further comprises means for decoding, using a first entropy decoder and the first probability model or a copy of the first probability model, the first bitstream into the first quantized latent tensor or a quantized latent tensor that is the same as the first quantized latent tensor. The apparatus further comprises means for generating, using a first dequantizer, a first resulting latent tensor. The apparatus further comprises means for converting, using a first neural decoder, the first resulting latent tensor into the initial reconstruction data.

The apparatus of an example embodiment further comprises means for converting, using a second neural encoder, the residual ground-truth data into a second latent tensor. The apparatus further comprises means for generating, using a second quantizer and a second predefined set of quantization levels, a second quantized latent tensor based at least on the second latent tensor, wherein the second quantized latent tensor comprises at least one symbol or element. The apparatus further comprises means for converting, using an auxiliary encoder, the auxiliary data into auxiliary features. The apparatus further comprises means for inputting the auxiliary features into a second probability model. The apparatus further comprises means for, for a respective symbol or element of the at least one symbol or element of the second quantized latent tensor, determining, using the second probability model, a second estimated probability distribution of possible values. The apparatus further comprises means for encoding, using a second entropy encoder, the respective symbol or element of the at least one symbol or element of the second quantized latent tensor into the second bitstream based at least on the second estimated probability distribution of possible values.

The apparatus of an example embodiment further comprises means for decoding, using a second entropy decoder, the auxiliary encoder or another auxiliary encoder that is the same as the auxiliary encoder, and the second probability model or another probability model that is the same as the second probability model, the second bitstream into the second quantized latent tensor or a quantized latent tensor that is the same as the second quantized latent tensor. The apparatus further comprises means for generating, using a second dequantizer, a second resulting latent tensor. The apparatus further comprises means for converting, using a second neural decoder, the second resulting latent tensor into the residual reconstruction data.

In an example embodiment, at least one of the first neural encoder, the first neural decoder, the first probability model, the second neural encoder, the second neural decoder, the second probability model, and the auxiliary encoder comprise neural network components.

In an example embodiment, the first codec and the second codec are trained in an end-to-end manner by decreasing at least one of distortion loss and rate loss.

In an example embodiment, the first codec is trained before the second codec, and wherein the second codec is trained based at least on the first codec or based at least on data that is generated by the first codec.

In an example embodiment, the first codec and the second codec are trained simultaneously.

In an example embodiment, the first codec and the second codec are trained at alternating intervals.

In an example embodiment, the auxiliary data comprises one or more of the initial reconstruction data, the first latent tensor, and the first resulting latent tensor.

In an example embodiment, the residual ground-truth data is determined by the first codec.

In an example embodiment, the combined reconstruction data is determined by the second codec.

The apparatus of an example embodiment further comprises means for determining additional residual ground-truth data, based at least on the combined reconstruction data and the ground-truth data. The apparatus further comprises means for determining additional auxiliary data based at least on the second bitstream or based at least on data derived from the second bitstream. The apparatus further comprises means for receiving, by a different codec, the additional residual ground-truth data and the additional auxiliary data. The apparatus further comprises means for, based at least on the additional residual ground-truth data and the additional auxiliary data, generating an additional bitstream. The apparatus further comprises means for, based on the additional bitstream, generating additional reconstruction data, wherein the additional reconstruction data comprises a reconstruction of the additional residual ground-truth data, and wherein the additional reconstruction data is operable to combine with the combined reconstruction data to form compounded reconstruction data. The apparatus further comprises means for outputting, by the different codec, at least one of the additional reconstruction data and the compounded reconstruction data.

In an example embodiment, an apparatus is provided comprising means for receiving a first bitstream. The apparatus further comprises means for, based on the first bitstream, generating initial reconstruction data. The apparatus further comprises means for determining auxiliary data based at least on the first bitstream or based at least on data derived from the first bitstream. The apparatus further comprises means for outputting the initial reconstruction data.

The apparatus further comprises means for receiving a second bitstream. The apparatus further comprises means for, based on the second bitstream and the auxiliary data, generating residual reconstruction data. The apparatus further comprises means for outputting the residual reconstruction data.

The apparatus of an example embodiment further comprises means for determining combined reconstruction data based at least on the initial reconstruction data and the residual reconstruction data.

In an example embodiment, the first bitstream and the second bitstream are received as parts of a combined bitstream.

The apparatus of an example embodiment further comprises means for decoding, using a first entropy decoder and a first probability model, the first bitstream into a first quantized latent tensor. The apparatus further comprises means for generating, using a first dequantizer and based on the first quantized latent tensor, a first latent tensor. The apparatus further comprises means for converting, using a first neural decoder, the first latent tensor into the initial reconstruction data.

The apparatus of an example embodiment further comprises means for decoding, using a second entropy decoder, an auxiliary encoder, and a second probability model, the second bitstream into a second quantized latent tensor. The apparatus further comprises means for generating, using a second dequantizer and based on the second quantized latent tensor, a second latent tensor. The apparatus further comprises means for converting, using a second neural decoder, the second latent tensor into the residual reconstruction data.

In an example embodiment, at least one of the first neural decoder, the first probability model, the second neural decoder, and the second probability model comprise neural network components.

The apparatus of an example embodiment further comprises means for receiving an additional bitstream. The apparatus further comprises means for, based on the additional bitstream, generating additional reconstruction data, wherein the additional reconstruction data is operable to combine with the combined reconstruction data to form compounded reconstruction data. The apparatus further comprises means for outputting at least one of the additional reconstruction data and the compounded reconstruction data.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of an example communication system in which example embodiments of the present disclosure may be deployed;

FIG. 2 is a block diagram of a system including both a service device and a user device designed to perform functions in accordance with example embodiments herein;

FIG. 3 is an illustration of a codec using neural networks as components of a pipeline in accordance with previous embodiments;

FIG. 4A is an illustration of a video coding pipeline utilizing neural networks in accordance with previous embodiments;

FIG. 4B is an illustration of a video coding pipeline utilizing neural networks on the encoding and decoding sides in accordance with previous embodiments;

FIG. 5 is an illustration of a neural network-based end-to-end learned video coding system in accordance with previous embodiments;

FIG. 6A is an illustration of a VCM pipeline in accordance with previous embodiments;

FIG. 6B is an illustration of a VCM pipeline using an end-to-end learned approach in accordance with previous embodiments;

FIG. 7 is an illustration of training an end-to-end learned system in accordance with previous embodiments;

FIG. 8 is an illustration of an example dense split attention block in accordance with example embodiments of the present disclosure;

FIG. 9 is an illustration of an end-to-end learned intra frame codec in accordance with example embodiments of the present disclosure;

FIG. 10 is block diagram of a system with more than two codecs in accordance with example embodiments of the present disclosure;

FIG. 11 is a flowchart demonstrating operations performed, such as by the apparatus of FIG. 2, in order to generate bitstreams based on ground-truth data;

FIG. 12 is a flowchart demonstrating operations performed, such as by the apparatus of FIG. 2, in order to encode a first bitstream;

FIG. 13 is a flowchart demonstrating operations performed, such as by the apparatus of FIG. 2, in order to generate initial reconstruction data;

FIG. 14 is a flowchart demonstrating operations performed, such as by the apparatus of FIG. 2, in order to encode a second bitstream;

FIG. 15 is a flowchart demonstrating operations performed, such as by the apparatus of FIG. 2, in order to generate residual reconstruction data;

FIG. 16 is a flowchart demonstrating operations performed, such as by the apparatus of FIG. 2, in order to output additional reconstruction data;

FIG. 17 is a flowchart demonstrating operations performed, such as by the apparatus of FIG. 2, in order to output residual reconstruction data;

FIG. 18 is a flowchart demonstrating operations performed, such as by the apparatus of FIG. 2, in order to generate initial reconstruction data;

FIG. 19 is a flowchart demonstrating operations performed, such as by the apparatus of FIG. 2, in order to generate residual reconstruction data; and

FIG. 20 is a flowchart demonstrating operations performed, such as by the apparatus of FIG. 2, in order to output additional reconstruction data.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

Additionally, as used herein, the term ‘circuitry’ may refer to one or more or all of the following: (a) hardware-only circuit implementations (such as implementations in analog circuitry and/or digital circuitry); (b) combinations of circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and/or processor(s), such as a microprocessor(s) or a portion of a microprocessor(s), that requires software (e.g., firmware) for operation, but the software may not be present when needed for operation. This definition of ‘circuitry’ applies to all uses of this term in this application, including in any claims. As a further example, as used in this application, the term ‘circuitry’ also covers an implementation of merely a hardware circuit or processor (or multiple processors) or portions of a hardware circuit or processor and its (or their) accompanying software and/or firmware. The term ‘circuitry’ also covers, for example and if applicable to the particular claim element, a baseband integrated circuit or processor integrated circuit for a mobile phone or a similar integrated circuit in a server, a cellular network device or other computing or network device.

Additionally, as used herein, the terms “model”, “neural network”, “neural net” and “network” are used interchangeably. In addition, the weights of neural networks may be referred to as learnable parameters or parameters.

Additionally, as used herein, the terms “machine” and “task neural network” are used interchangeably, to mean any process or algorithm (learned or not from data) which analyzes or processes data for a certain task.

Additionally, as used herein, the terms “receiver-side” and “decoder-side” refer to the physical or abstract entity or device which may contain one or more machines, and may run these one or more machines on some encoded and eventually decoded video representation which is encoded by another physical or abstract entity or device, the “encoder-side device”.

Additionally, as used herein, the terms “intra frame”, “frame”, and “image” may be used interchangeably. These terms may refer to at least part of the input data and at least part of the output data of an end-to-end (e2e) learned intra-frame codec. In one or more embodiments, these terms refer to image as the data type. However, the proposed embodiments can be extended to other types of data such as video, audio, and etc.

As defined herein, a “computer-readable storage medium,” which refers to a physical storage medium (e.g., volatile or non-volatile memory device), may be differentiated from a “computer-readable transmission medium,” which refers to an electromagnetic signal.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged. A process may be terminated when its operations are completed but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

Example embodiments may be utilized in conjunction with RANs such as: Universal Mobile Telecommunications System (UMTS); Global System for Mobile communications (GSM); Advance Mobile Phone Service (AMPS) system; the Narrowband AMPS system (NAMPS); the Total Access Communications System (TACS); the Personal Digital Cellular (PDC) system; the United States Digital Cellular (USDC) system; the code division multiple access (CDMA) system described in EIA/TIA IS-95; a High Rate Packet Data (HRPD) system, Worldwide Interoperability for Microwave Access (WiMAX); Ultra Mobile Broadband (UMB); and 3rd Generation Partnership Project LTE (3GPP LTE).

As described herein, a method, apparatus and computer program product are provided for video and image compression and reconstruction using end-to-end learned coder-decoders.

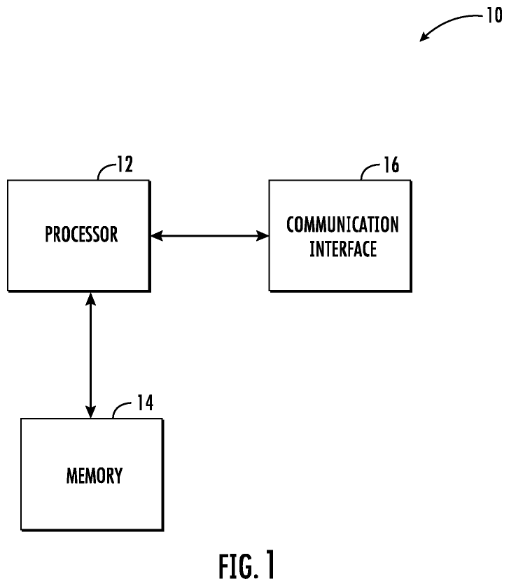

In order to carry out end-to-end learned compression and reconstruction, an apparatus 10 is provided as shown, for example, in FIG. 1. The apparatus may be embodied by or in communication with any of a variety of different types of computing devices including, for example, a video processing system, an image processing system or any other system configured to decompress images captured by a snapshot compressive sensing system. As shown in FIG. 1, the apparatus of an example embodiment includes, is associated with or is otherwise in communication with a processor 12, an associated memory 14 and a communication interface 16.

The processor 12 (and/or co-processors or any other circuitry assisting or otherwise associated with the processor) may be in communication with the memory device 14 via a bus for passing information among components of the apparatus 10. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present disclosure. For example, the memory device could be configured to buffer input data for processing by the processor. Additionally or alternatively, the memory device could be configured to store instructions for execution by the processor.

The apparatus 10 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12 may be embodied in a number of different ways. For example, the processor may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 12 may be configured to execute instructions stored in the memory device 14 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present disclosure while configured accordingly. Thus, for example, when the processor is embodied as an ASIC, FPGA or the like, the processor may be specifically configured hardware for conducting the operations described herein. Alternatively, as another example, when the processor is embodied as an executor of instructions, the instructions may specifically configure the processor to perform the algorithms and/or operations described herein when the instructions are executed. However, in some cases, the processor may be a processor of a specific device (e.g., an image processing system) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The communication interface 16 may be any means such as a device or circuitry embodied in either hardware or a combination of hardware and software that is configured to receive and/or transmit data, such as by receiving frames from a snapshot compressive sensing system or from an external memory device and/or for providing the reconstructed signal to an imaging system or other type of display for presentation or to an external memory device for storage. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

The processor 12 may be configured to carry out instructions of a computer program by performing the arithmetical, logical, and input/output operations of the system. Instructions may be provided to the processor 12 by the memory 14.

Various interfaces of the device 10 may include components that interface the processor 12 with an antenna, or other input/output components. As will be understood, the interfaces and programs stored in the memory 14 to set forth the special purpose functionalities of the apparatus 10 will vary depending on the implementation of the apparatus 10.

In one example embodiment, the apparatus 10 may be any known or to be developed device including, but not limited to, a cellular phone, a laptop, a tablet, a personal computer, a portable media device such as a television set, a multi-functional camera, a drone, an electric vehicle, etc.

Video and image compression codecs are devices or computer programs that encode and/or de-code, e.g., a digital data stream, bitstream, sequence of pictures, a signal, or the like, related to video and/or images. Still image codecs can comport with standards such as JPEG, GIF, PNG, or the like. Video codecs can comport with standards such as Cinepak, MPEG, MPEG-2, H.264, VP8, H.265, or the like.

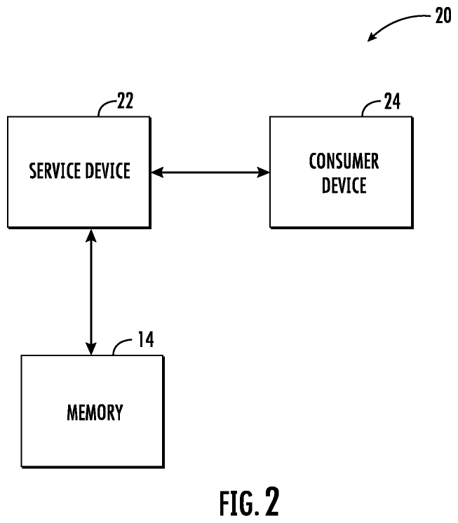

Turning now to FIG. 2, an example system for implementing the end-to-end codec is provided. In this example embodiment, service device 22 may perform encoding (where encoding may comprise performing also decoding) of an input image or video. In one or more embodiments, service device 22 may transmit encoded bitstream data resulting from the input image to consumer device 24. In an example embodiment, the bitstream data may be transmitted wirelessly over a network. In an example embodiment, the bitstream data may be transmitted through wired connection between service device 22 and consumer device 24. In one or more embodiments, consumer device 24 may decode the bitstream data received from service device 22 into one or more reconstructed images or videos. In one or more embodiments, service device 22 may save bitstream data to a memory 14. Memory 14 may be internal or external to service device 22. In one or more embodiments, service device 22 is able to retrieve the bitstream data from memory 14 and reconstruct the input image. In one or more embodiments, service device 22 and/or consumer device 24 may be embodied by the apparatus 10.

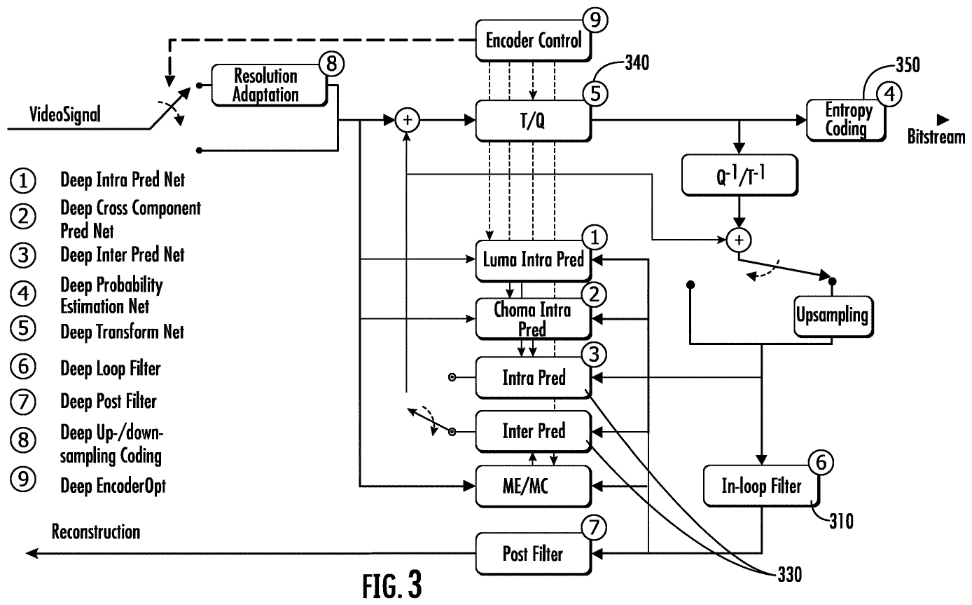

Turning now to FIG. 3, an example of a previous embodiment of a codec 300 using neural networks as part of a pipeline is provided. In one or more embodiments, the in-loop filter 310 may comprise a neural network. In one example, the in-loop filter 310 comprises one or more neural network based in-loop filters and one or more non-neural network based in-loop filters. In another example, the in-loop filter 310 comprises only one or more neural network based in-loop filters. In one or more embodiments, the intra-frame prediction 320 may comprise one or more neural networks. In one or more embodiments, the inter-frame prediction 330 may comprise one or more neural networks. In one or more embodiments, the transforms and/or inverse transforms 340 may comprise one or more neural networks. In one or more embodiments, the lossless coding (e.g., entropy coding) 350 may comprise or use a neural network based probability model. Other neural networks may be used throughout the pipeline in various embodiments.

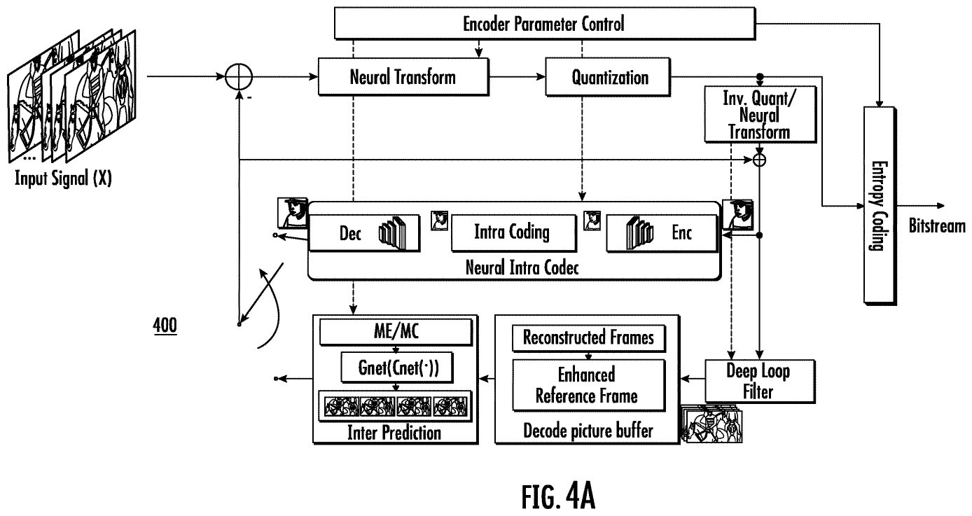

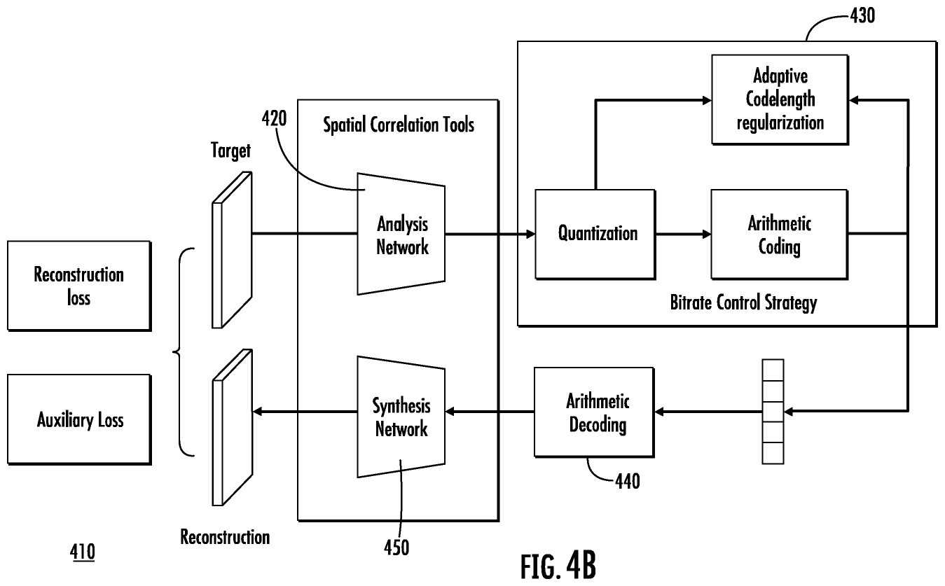

Turning now to FIG. 4A, an illustration is provided for a previous embodiment of a video coding pipeline 400 with the main components replaced with neural networks. Video coding pipeline 400 uses an end-to-end learned compression approach with neural networks. FIG. 4B illustrates an example pipeline 410 that uses neural networks on the encoder and decoder sides. In one or more embodiments, the pipeline 410 comprises an analysis network 420, quantization means and an arithmetic encoder in block 430, an arithmetic decoder 440, and synthesis network 450. In one or more embodiments, analysis network 420 comprises an encoder neural network and synthesis network 450 comprises a decoder neural network. In one or more embodiments, analysis network 420 and synthesis network 450 are part of a neural auto-encoder architecture. In one or more embodiments, analysis network 420 is configured to perform a non-linear transform and synthesis network 450 is configured to perform a non-linear inverse transform.

One or more embodiments, the input data is analyzed by the analysis network 420, which outputs a new representation of that input data. The new representation may be more compressible. This new representation may then be quantized to a discrete number of values in block 430. The quantized data is then lossless encoded, for example by an arithmetic encoder in block 430, thus obtaining a bitstream. On the decoding side, the bitstream is first lossless decoded, for example by using an arithmetic decoder 440. The lossless decoded data is dequantized and then input to the synthesis network 450. The output is the reconstructed or decoded data.

In one or more embodiments where lossy compression is performed, the lossy steps may comprise analysis network 420 and quantization in block 430.

In an example embodiment, in order to train pipeline 410, a training objective function (also called “training loss”) is typically used, which may comprises one or more terms, or loss terms, or simply losses. In an example embodiment, the training loss comprises a reconstruction loss term and a rate loss term. In an example embodiment, the reconstruction loss encourages the system to decode data that is similar to the input data, according to some similarity metric. Examples of reconstruction losses include mean squared error (MSE), multi-scale structural similarity (MS-SSIM), losses derived from the use of a pretrained network, losses derived from the use of a neural network that is trained simultaneously with the end-to-end learned codec, or the like. An example of losses derived from the use of a pretrained network is error(f1, f2), where f1 and f2 are features extracted by a pretrained neural network for the input data and the decoded data, respectively, and error( ) is an error or distance function, such as L1 norm or L2 norm. An example of losses derived from the use of a neural network that is trained simultaneously with the end-to-end learned codec is adversarial loss, which is the loss provided by a discriminator neural network that is trained adversarial with respect to the codec, following the settings proposed in the context of Generative Adversarial Networks (GANs) and their variants.

Rate loss may encourage the system to compress (i.e., reduce the number of bits) the output of the encoding stage, such as the output of the arithmetic encoder. In one or more embodiments, when an entropy-based lossless encoder is used (e.g., an arithmetic encoder), the rate loss encourages the output of analysis network 420 to have low entropy. Examples of rate losses include a differentiable estimate of the entropy, a sparsification loss, (i.e., a loss that encourages the output of the analysis network 420 or the output of the quantization to have many zeros such as L0 norm, L1 norm, L1 norm divided by L2 norm), a cross-entropy loss applied to the output of a probability model, where the probability model may be a neural network used to estimate the probability of the next symbol to be encoded by an arithmetic encoder, or the like.

In one or more embodiments, one or more of reconstruction losses may be used, and one or more of the rate losses may be used, as a weighted sum. In one or more embodiments, the different loss terms are weighted using different weights, and these weights determine how the final system performs in terms of rate-distortion loss. For example, if more weight is given to the reconstruction losses with respect to the rate losses, the system may learn to compress less but to reconstruct with higher accuracy (as measured by a metric that correlates with the reconstruction losses). In one or more embodiments, these weights are hyper-parameters of the training session and may be set manually by the person designing the training session, or automatically for example by grid search or by using additional neural networks.

In one or more embodiments, non-neural networks may be used in end-to-end learned approaches, such as arithmetic codecs.

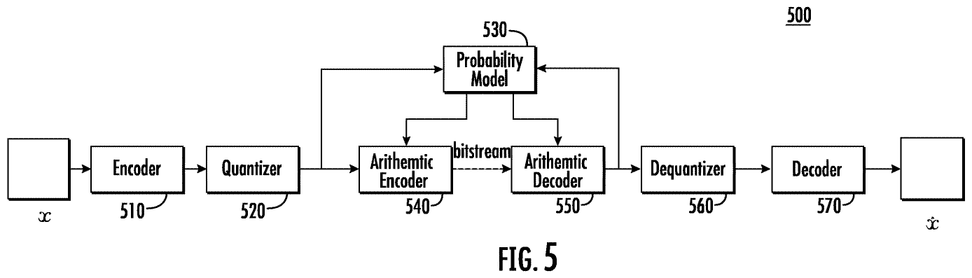

Turning now to FIG. 5, a neural network-based end-to-end learned video coding system 500 in accordance with previous embodiments is provided. In one or more embodiments, system 500 contains encoder 510, quantizer 520, probability model 530, an entropy codec (arithmetic encoder 540 and arithmetic decoder 550), dequantizer 560, and decoder 570. In one or more embodiments, the encoder 510 and decoder 570 are two neural networks. In one or more embodiments, encoder 510 and decoder 570 mainly comprise neural network components. In one or more embodiments, probability model 530 comprises mainly neural network components. In one or more embodiments, quantizer 520, dequantizer 560, and the entropy codec are not based on neural network components. In one or more alternative embodiments, these components do comprise neural network components.

In one or more embodiments, encoder 510 takes a video as input and converts the video from its original signal space into a latent representation (also referred to as latent tensor) that may comprise a more compressible representation of the input. In one or more embodiments, in the case of an input image, the latent representation may be a 3-dimensional tensor, where two dimensions represent the vertical and horizontal spatial dimensions, and the third dimension represent the “channels” which contain information at that specific location. In one or more embodiments wherein the input image is a 128×128×3 RGB image (with horizontal size of 128 pixels, vertical size of 128 pixels, and 3 channels for the Red, Green, Blue color components), and encoder 510 downsamples the input tensor by 2 and expands the channel dimension to 32 channels, the latent representation comprises a tensor of dimensions (or “shape”) 64×64×32 (i.e., with horizontal size of 64 elements, vertical size of 64 elements, and 32 channels). In various embodiments, the order of the different dimensions may differ depending on the convention which is used. In an example embodiment, for the input image, the channel dimension may be the first dimension. In this example, the above shape of the input tensor may be represented as 3×128×128, instead of 128×128×3. In an example embodiment with an input video, another dimension in the input tensor may be used to represent temporal information. In an example embodiment, quantizer 520 quantizes the latent representation into discrete values given a predefined set of quantization levels. The output of the quantizer 520 may be referred to as quantized latent tensor. In one or more embodiments, probability model 530 and the arithmetic codec component work together to perform lossless compression for the quantized latent representation and generate bitstreams to be sent to the decoder side. Given a symbol to be encoded into the bitstream, the probability model 530 estimates the probability distribution of all possible values for that symbol based on a context that is constructed from available information at the current encoding/decoding state, such as the data that has already been encoded/decoded. In one or more embodiments, arithmetic encoder 540 encodes the input symbols to bitstream using the estimated probability distributions.

In one or more embodiments, on the decoder side, opposite operations are performed. In one or more embodiments, the arithmetic decoder 550 and the probability model 530 first decode symbols from the bitstream to recover the quantized latent representation. In one or more embodiments, dequantizer 560 then reconstructs the latent representation in continuous values and passes it to decoder 570 to recover the input video/image. In one or more embodiments, the probability model 530 is shared between the encoding and decoding systems. In example embodiments, a copy of the probability model is used at encoder side, and another exact copy is used at decoder side.

In an example embodiment of system 500, the encoder 510, probability model 530, and decoder 570 are based on deep neural networks. In an example embodiment, the system is trained in an end-to-end manner by minimizing the following rate-distortion loss function: L=D+λR. In an example embodiment, D is the distortion loss term, R is the rate loss term, and λ is the weight that controls the balance between the two losses. In an example embodiment, the distortion loss term may be the mean square error (MSE), structure similarity (SSIM) or other metrics that evaluate the quality of the reconstructed video. In one or more embodiments, multiple distortion losses may be used and integrated into D, such as a weighted sum of MSE and SSIM. In one or more embodiments, the rate loss term is the estimated entropy of the quantized latent representation, which indicates the number of bits necessary to represent the encoded symbols, for example, bits-per-pixel (bpp).

In an example system for lossless video/image compression, the system may contain only probability model 530, arithmetic encoder 540, and arithmetic decoder 550. In one or more embodiments, the system loss function contains only the rate loss, since the distortion loss is always zero (i.e., no loss of information).

In one or more embodiments, decoded data may be analyzed by machines. Examples of such analysis are object detection, scene classification, semantic segmentation, video event detection, anomaly detection, pedestrian tracking, etc. Example use cases and applications include self-driving cars, video surveillance cameras and public safety, smart sensor networks, smart TV and smart advertisement, person re-identification, smart traffic monitoring, drones, and/or the like. In one or more embodiments, different quality metrics and dedicated algorithms for compressing and decompressing data for machine consumption may be used than those for compressing and decompressing data for human consumption. The set of tools and concepts for compressing and decompressing data for machine consumption is referred to here as Video Coding for Machines.

In one or more embodiments, a receiver-side device has multiple “machines” or neural networks (NNs). In one or more embodiments, these multiple machines may be used in a certain combination determined by an orchestrator sub-system. In one or more embodiments, the multiple machines may be used in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

In one or more embodiments, the encoded video data may be stored into a memory device, for example as a file. In one or more embodiments, the stored file may later be provided to another device. In one or more alternative embodiments, the encoded video data may be streamed from one device to another.

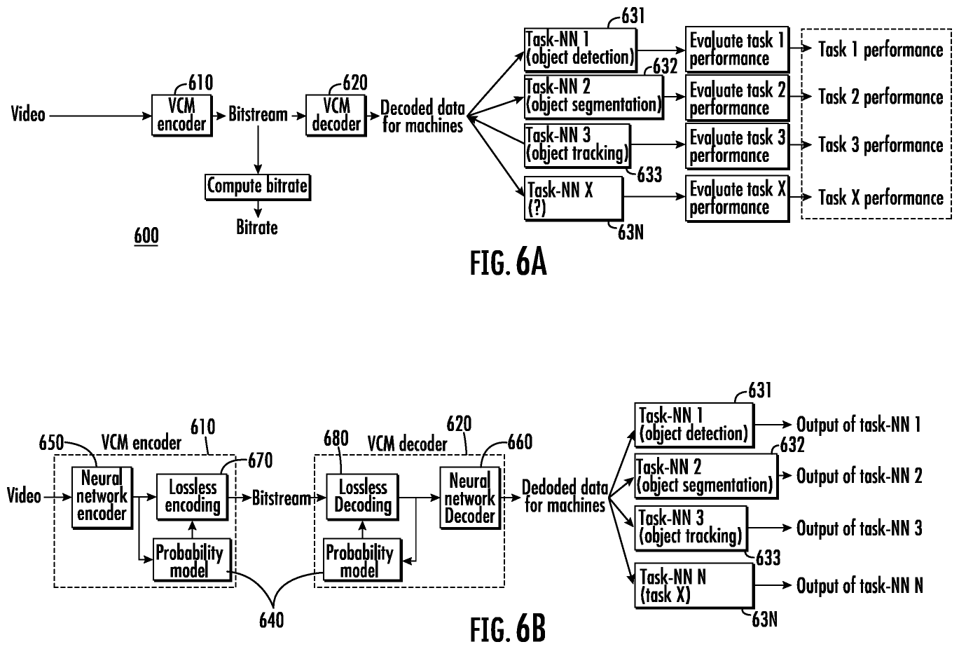

Turning now to FIG. 6A, an illustration of the pipeline of Video Coding for Machines 600 in accordance with previous embodiments is provided. In one or more embodiments, a VCM encoder 610 encodes the input video into a bitstream. In one or more embodiments, a bitrate may be computed from the bitstream in order to evaluate the size of the bitstream. In one or more embodiments, a VCM decoder 620 decodes the bitstream output by the VCM encoder 610. In one or more embodiments, the output from VCM decoder 620 comprises decoded data for machines. In one or more embodiments, this data may be decoded or reconstructed video. However, in one or more embodiments, this data may not have same or similar characteristics as the original video which was input to the VCM encoder 610. For example, this data may not be easily understandable by a human by simply rendering the data onto a screen. In one or more embodiments, the output of VCM decoder 620 is then input to one or more task neural networks 631-63N. In one or more embodiments, there may be any number of task neural networks. In one or more embodiments, VCM 600 has a purpose to obtain a low bitrate while guaranteeing that the task-NNs 631-63N perform well in terms of the evaluation metric associated to each task.

In one or more embodiments, an end-to-end learned approach to realize video coding for machines may be used. In one or more embodiments, the VCM encoder 610 and VCM decoder 620 mainly consist of neural networks. FIG. 6B illustrates an example of a pipeline for the end-to-end learned approach in accordance with previous embodiments. In one or more embodiments, the video is input to a neural network encoder 650. In one or more embodiments, the output of the neural network encoder is input to a lossless encoder 670, such as an arithmetic encoder, which outputs a bitstream. In one or more embodiments, the lossless codec may comprise a probability model 640, both in the lossless encoder 670 and in lossless decoder 680, which predicts the probability of the next symbol to be encoded and decoded. In one or more embodiments, the probability model 640 may be learned, for example it may be a neural network. In one or more embodiments, at the decoder-side, the bitstream is input to a lossless decoder 680, such as an arithmetic decoder, whose output is input to a neural network decoder 660. In one or more embodiments, the output of the neural network decoder 660 is the decoded data for machines, that may be input to one or more task-NNs 631-63N.

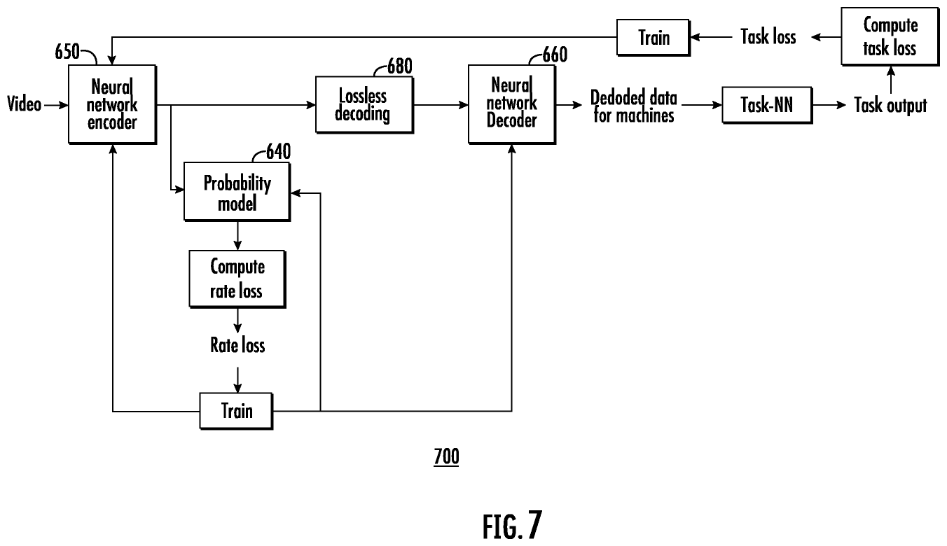

Turning now to FIG. 7, an example of how an end-to-end learned system 700 may be trained in accordance with previous embodiments. For the sake of simplicity, only one task-NN 631 is illustrated, but any number of task-NNs may be used. In one or more embodiments, a rate loss may be computed from the output of the probability model 640. In one or more embodiments, the rate loss provides an approximation of the bitrate required to encode the input video data. In one or more embodiments, a task loss may be computed from the output of the task-NN 631.

In one or more embodiments, the rate loss and the task loss may then be used to train the neural networks used in the system, such as the neural network encoder 650, the probability model 640, the neural network decoder 660. In one or more embodiments, training may be performed by first computing gradients of each loss with respect to the neural networks that are contributing or affecting the computation of that loss. In one or more embodiments, the gradients are then used by an optimization method, such as Adam, for updating the trainable parameters of the neural networks.

In one or more embodiments, machine tasks may be performed at decoder side rather than the encoder side. For example, this may be done because the encoder-side device does not have the capabilities (computational, power, memory) for running the neural networks that perform these tasks. As another example, this may be done because some aspects or the performance of the task neural networks have changed or improved by the time that the decoder-side device needs the tasks results (e.g., different or additional semantic classes, better neural network architecture). In one or more embodiments, there could be a customization need, where different clients would run different neural networks for performing these machine learning tasks.

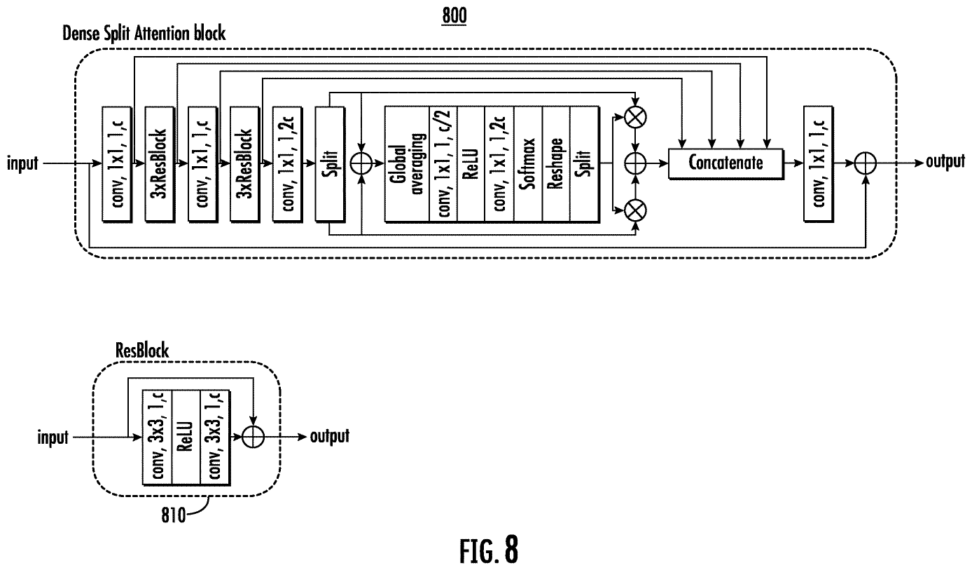

Turning now to FIG. 8, an example Dense Split Attention (DSA) 800 block is provided in accordance with an example embodiment, wherein one type of NN layer is a Resblock 810 comprising NN layers. In one or more embodiments, DSA 800 is an attention block that estimates one or more attention maps and applies the one or more attention maps to one or more data tensors. In one or more embodiments, an attention map may be a vector, a matrix or a tensor. In one example, an attention map may have values in the range [0, 1]. In one or more embodiments, one or more data tensors may comprise one or more input tensors to the attention block 800, one or more feature maps that are extracted within the attention block 800, and/or one or more feature maps that are extracted outside of the attention block 800. In one or more embodiments, the application of the one or more attention maps to the one or more data tensors may comprise multiplying the one or more attention maps' values by the one or more data tensors, for example, by using element-wise multiplication operation. In one or more embodiments, other operations may be also considered.

In one or more embodiments, the DSA block 800 comprises extracting features from its input based at least on one or more initial NN layers. In one or more embodiments, DSA block 800 further comprises splitting the extracted features across the channel axis to obtain two split features. In one or more embodiments, DSA block 800 further comprises summing up the split features. In one or more embodiments, DSA block 800 further comprises performing a global averaging operation on the summed features. In one or more embodiments, DSA block 800 further comprises processing the output of the global averaging operation based at least on one or more NN layers. In one or more embodiments, DSA block 800 further comprises inputting the result of this processing to a Softmax operation. In one or more embodiments, DSA block 800 further comprises splitting the result of the Softmax operation across the channel axis to obtain two attention tensors. In one or more embodiments, DSA block 800 further comprises multiplying the two attention tensors with the previously determined two split features to obtain two attended split features. In one or more embodiments, DSA block 800 further comprises summing up the two attended split features. In one or more embodiments, DSA block 800 further comprises concatenating the summed attended split features with features determined based at least on the one or more initial NN layers. In one or more embodiments, DSA block 800 further comprises processing the result of the concatenation by means of at least one or more NN layers. In one or more embodiments, DSA block 800 further comprises summing the output of this processing with the input of the DSA block 800 to obtain the output of the DSA block 800. In one or more embodiments, the global averaging operation may be a global pooling (an average pooling) operation that calculates the average value for patches of a feature map. In one or more embodiments, the global averaging operation may aggregate spatial information of a feature map to a single channel to help exploit the inter-channel relationship of features.

In one or more embodiments, DSA block 800 may be used as one of the blocks for the image encoder and image decoder in an end-to-end learned codec. In the image encoder and image decoder, the DSA blocks may follow one or more convolutional layers or one or more transpose convolutional layers.

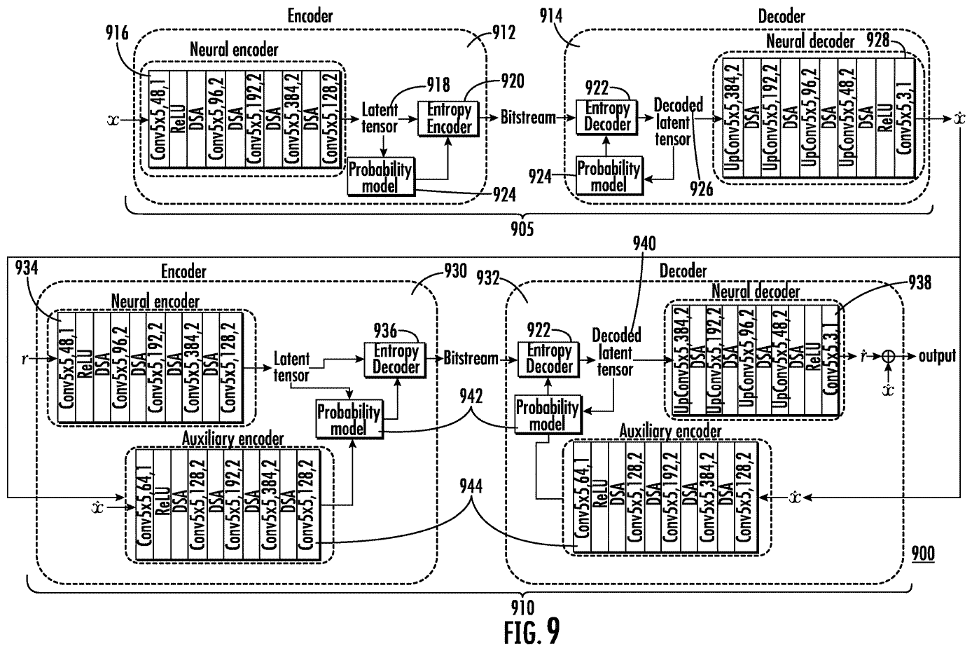

Turning now to FIG. 9, an end-to-end (e2e) learned intra frame codec 900 is provided for optimizing rate-distortion performance. Example embodiments herein refer to an end-to-end learned intra-frame codec. However, at least some embodiments described herein may also be applied to an end-to-end learned inter-frame codec used for video compression, or to an end-to-end learned video codec that compresses both intra and inter frames. The intra frame codec 900 comprises a first step codec 905 and a second step codec 910, where an output of the first step codec is an input to the second step codec. In one or more embodiments, the e2e intra-frame codec can process the input frame independently, without using any information from other frames. In one or more example embodiments, YUV is the format for data input into first-step codec 905. In embodiments where YUV format is used, YUV format, ‘Y’ represents the brightness, or ‘luma’ value; and ‘UV’ represents the color, or ‘chroma’ values. In one example, the input image may be an image in YUV 4:4:4 color format, represented as a 3-dimensional array (or tensor) with size 256×256×3, where the horizontal size is 256 pixels, vertical size is 256 pixels, and 3 channels are for Y, U, V components, respectively. In another example, the input image may be an image in YUV 4:2:0 color format, represented by the combination of a matrix of size 256×256 for the luma component and of a 2-dimensional array (or tensor) of size 128×128×2 for the chroma component. However, the proposed embodiments can also be extended to other formats such as RGB.

In one or more embodiments, end-to-end learned intra frame codec 900 comprises components including image encoders 916 and 934, quantizers, probability models 924 and 942, entropy encoders 920 and 936, entropy decoders 922 and 940, dequantizers, and image decoders 928 and 938. Entropy encoders 920 and 936 may comprise lossless encoders, for example, arithmetic encoders. In one or more embodiments, entropy decoders 922 and 940 may comprise lossless decoders, for example, arithmetic decoders. The image encoders 916 and 934, probability models 924 and 942, and image decoders 928 and 938 may comprise neural network components. In one or more embodiments, quantizers, entropy codec, and dequantizers may comprise neural network components.

In one or more embodiments, a codec comprises an encoder and a decoder. For example, first-step codec 905 comprises an encoder 912 and a decoder 914. In one or more embodiments, the encoder 912 may comprise the image encoder 916, the quantizer, the probability model 924, and the entropy encoder 920. In one or more embodiments, the decoder may comprise the entropy decoder 922, the probability model 924, the dequantizer, and the image decoder 928. In the illustrated embodiment, the probability model 924 in the encoder and the probability model 924 in the decoder are the same probability model. In this context, “same” may refer to two instances of the probability model, one probability model being a copy of another, two identical probability models, or both being embodied in the same instance of the probability model. Likewise, this use of “same” may be used to refer to auxiliary encoders and quantized latent tensors that are identical instances, copies, one embodiment. For the sake of simplicity, identical instances of probability models and auxiliary encoders are labeled with the same numbers in FIG. 9.

In one or more embodiments, the intra-frame codec includes two steps to code the input data: a first-step codec 905 and second-step codec 910. In one or more embodiments, the first-step codec comprises an encoder 912 that takes ground-truth data as input and outputs a first bitstream. Ground truth data may be the data to be compressed. However, a codec, such as the first step codec, may take other inputs in addition to the ground truth data, such as an indication of the desired quality of the reconstructed data, or an indication of the desired bitrate of the encoded data, or an indication of a characteristic of the ground truth data, such as its resolution (in the case of image or video data). In one or more embodiments, the first step codec comprises a decoder 914 that takes as input the first bitstream and outputs an initial reconstruction of input data. In one or more embodiments the encoder 930 of second-step codec 910 takes a residual, where the residual is computed based on the ground truth and the reconstruction from first-step codec. In one or more embodiments, the probability model 942 of second-step codec 910 takes the reconstruction from first-step codec 905 as an auxiliary input. In one or more embodiments, the encoder 930 of second-steps codec 910 outputs a second bitstream. In one or more embodiments, the decoder 932 of second-step codec 910 takes as input the second bitstream and reconstructs the residual. In one or more embodiments, the reconstructed residual from the second-step codec 910 is added to the reconstruction from the first-step codec 910 to get the final reconstruction of the ground truth. In one or more embodiments, the sum of bitstream output by the encoder 912 of first-step codec 905 (i.e., the first bitstream) and bitstream output by the encoder 930 of second-step codec 910 (i.e., second bitstream) represents the encoded ground truth.

This embodiment provides technical advantages over prior embodiments of coder-decoders. In one or more embodiments, with the auxiliary input to the probability model of second-step codec 910, the second-step codec is conditioned on the initial reconstruction of the input data, which improves the rate-distortion performance of the second-step codec 910. Therefore, the rate-distortion performance of the whole codec 900 (the combination of the first-step codec 905 and the second-step codec 910) is improved.

In one or more embodiments, the e2e learned intra-frame codec 900 may be used as part of a video codec, where the intra-frame codec may code one or more first frames (e.g., intra frames) of a video independently from any other frame, and where another codec that comprises an inter-frame codec may code one or more second frames of a video based at least on one or more third frames, wherein the one or more third frames may comprise zero or more of the one or more first frames and/or zero or more of the oner or more second frames. However, in one or more embodiments, the e2e learned intra-frame codec 900 may be used to code a subset of all the frames that are coded independently from any other frame (i.e., a subset of all the intra frames in a video sequence). In one example, the e2e learned intra-frame codec 900 is used to code a first subset of all the intra-frames in a video, a conventional intra-frame codec is used to code a second subset of all the intra-frames in the video, and a conventional inter-frame codec is used to code the inter-frames of the video.

In one or more embodiments, at encoder 912, the image encoder 916 takes an image as input and converts the image into a latent tensor. In one or more embodiments, given a predefined set of quantization levels, the quantizer quantizes the latent tensor into discrete values to obtain a quantized latent tensor. In one or more embodiments, for each symbol or element in the quantized latent tensor, the probability model 924 estimates the probability distribution of all possible values based on a context which is constructed from available information at the current encoding/decoding state. In one or more embodiments, the arithmetic encoder 920 encodes (in a lossless manner) the input symbols or elements into a bitstream based at least on the estimated probability distributions. In one or more embodiments, this series of steps comprises image compression/encoding and the resulting bitstream represents the compressed or encoded image.

In one or more embodiments, at decoder 914, the arithmetic decoder 922 and the probability model 924 first decode the bitstream to recover the quantized latent tensor. In one or more embodiments, the probability model 924 used at decoder 914 may be required to be the same probability model 924 used at encoder side. In one or more embodiments, the dequantizer then reconstructs the latent tensor in continuous values and passes it to image decoder 928 to obtain a reconstruction of the input image. In one or more embodiments, the process at decoder 914 describes image decompression/decoding and the resulting image represents the reconstructed, or decoded, or decompressed image (these terms may be used as synonyms in at least some of the present embodiments).

In one or more embodiments, learned intra-frame codec 900 may be trained in an end-to-end manner by minimizing D+λR, where D is the distortion loss term, R is the rate loss term, and λ is the weight that controls the balance between the two losses. In one or more embodiments, an applied optimization process results in a rate-distortion trade-off, where a balance is found between the distortion D and the rate loss R. In one or more embodiments, the rate loss R may indicate a bitrate of the encoded image, and the distortion may indicate a pixel fidelity distortion such as mean-squared error (MSE), multi-scale structural similarity (MS-SSIM), multiple distortion losses such as a weighted sum of MSE and MS-SSIM, or other metrics that evaluate the quality of the reconstructed image.

In one or more embodiments, the distortion may be related to a performance of one or more machine analysis tasks or to an estimated performance of one or more machine analysis tasks. In one or more embodiments, the one or more machine analysis tasks may comprise object detection, image segmentation, instance segmentation, and/or the like. In one or more embodiments, the estimated performance of the one or more machine analysis tasks may comprise a distortion computed based at least on a first set of features extracted from an output of a decoder 914 or 932 and a second set of features extracted from a respective ground truth data, where the first set of features and the second set of features are output by one or more layers of a pretrained feature-extraction neural network.

In one or more embodiments, optimization or training may be performed jointly with respect to the distortion loss D and the rate loss R. In one or more embodiments, optimization or training may be performed in two alternating phases, where in a first phase of the two alternating phases only the distortion loss D may be used, and in a second phase of the two alternating phases only the rate loss R may be used.

As illustrated in FIG. 9, in one or more embodiments intra-frame codec 900 includes a first codec 905 that is used to initially code the input image and may be referred to as first-step codec, and a second codec 910 that is used to code the residual of the ground truth (e.g., the difference between the output of the decoder in the first-step codec and the respective ground truth data) and may be referred to as second-step codec. In one or more embodiments, the input to the first-step codec 905 may comprise a ground truth (e.g. a block or whole image) or part of the ground truth (e.g. masked ground truth). One example of input data into first-step codec 905 is a ground truth. For example, the ground truth may be an image in YUV 4:4:4 color format, represented as a 256×256×3 multi-dimensional array or tensor, where the horizontal size is 256 pixels, vertical size is 256 pixels, and 3 channels are for Y, U, V components, respectively. In another example, the ground truth may be an image in YUV 4:2:0 color format, represented by the combination of a matrix of size 256×256 for the luma component and of a 2-dimensional array (or tensor) of size 128×128×2 for the chroma component. In another example, the ground truth may include luma component only, represented as a 1-dimensional array (or tensor) with size 256×256×1. In another example, the ground truth may include chroma component only, represented as a 2-dimensional array (or tensor) with size 128×28×2. Another example of input data into first-step codec 905 is partial ground truth. For example, the input data may be the result of ground truth multiplied with a mask or an output of gaussian filter. In one or more example embodiments, in addition, the input to the first-step codec 905 may comprise one or more extra data, such as block/image resolution.

In the example embodiment depicted in FIG. 9, input data x is a ground truth including both luma component and chroma component, with h×w×3 describing the size of x with height h, width w and number of channels 3. In one or more embodiments, the first-step codec 905 is used to initially code the input data with encoder 916. In one or more embodiments, the output of decoder 914 represents the initial reconstruction of input data.

In one or more embodiments, the encoder 912 of first-step codec 905 may comprise a neural encoder 916, a quantizer, a probability model 924, and an entropy encoder 920. The quantizer is not illustrated in FIG. 9, but is present in one or more embodiments. In one or more embodiments, the neural encoder 916 may comprise a first convolutional layer (‘Conv5×5, 48, 1’, where conv stands for convolution, 5×5 is the kernel size, 48 is the number of output channels, and 1 is the stride value), followed by a non-linear activation function ReLU, followed by a first DSA block, followed by a second convolutional layer, followed by a second DSA block, followed by a third convolutional layer, followed by a third DSA block, followed by a fourth convolutional layer, followed by a fourth DSA block, followed by a fifth convolutional layer. In one or more embodiments, the neural encoder 916 outputs a latent tensor. In one or more embodiments, the latent tensor is converted by a quantizer into a quantized latent tensor. In one or more embodiments, the latent tensor or a quantized latent tensor may be input to probability model 924, with the dimensions of the latent tensor describing h//16×w//16×128, where h//16 indicates the height, w//16 indicates the width, and 128 indicates the number of channels. In one or more embodiments, the probability model 924 outputs an estimate of the probability of each element of the (quantized) latent tensor. In one or more embodiments, the probability model 924 may be learned from data by using machine learning techniques—for example, the probability model 924 may be a neural network and may be trained jointly with the other neural networks in the codec. In one or more embodiments, at the encoder 912 side, the output of the probability model 924 is used as one of the inputs to an entropy encoder 920. In one or more embodiments, the entropy encoder may be an arithmetic encoder. In one or more embodiments, the entropy encoder 920 takes in at least the (quantized) latent tensor and the output of the probability model 924 and outputs a bitstream. In one or more embodiments, the latent tensor that is input to the entropy encoder may be first quantized.

In one or more embodiments, the decoder 914 of first-step codec 905 may comprise an entropy decoder 922, a probability model 924, a dequantizer, and a neural decoder 928. In FIG. 9, the dequantizer is not illustrated but is present in one or more embodiments. In one or more embodiments, the entropy decoder 922 may be an arithmetic decoder. In one or more embodiments, the entropy decoder 922 takes in at least the bitstream and the output of the probability model 924 and outputs a (quantized) decoded latent tensor. In one or more embodiments, the probability model 924 may need to be the same probability model that is available at encoder 912 side. In one or more embodiments, the decoded latent tensor may undergo dequantization. In one or more embodiments, the decoded latent tensor or the dequantized decoded latent tensor is then input to the neural decoder 928. In one or more embodiments, the neural decoder 928 may comprise a first transpose convolutional layer (‘UpConv5×5, 384, 2’, where UpConv refers to transpose convolution, 5×5 is the kernel size, 384 is the number of output channels, and 2 is the stride value), a first DSA block, a second transpose convolutional layer, a second DSA block, a third transpose convolutional layer, a third DSA block, a fourth transpose convolutional layer, a fourth DSA block, a non-linear activation function ReLU, and a convolutional layer. In one or more embodiments, the output & of the neural decoder 928 is an initial reconstruction of the input data x, where the size may be h×w×3.

In one or more embodiments, the input to the second-step codec 910 may comprise at least the residual between the ground truth (e.g. a block or whole image) and the initial reconstruction \hat{x} from the first-step codec. For example, the input into second-step codec 910 may comprises the residual between the ground truth and the initial reconstruction \hat{x} from the first-step codec 905. In one or more embodiments, the ground truth may be an image in YUV 4:4:4 color format, represented as a 256×256×3 multi-dimensional array or tensor, where the horizontal size is 256 pixels, vertical size is 256 pixels, and 3 channels are for Y, U, V components, respectively. In one or more embodiments, the output \hat{x} of the first-step codec 905 represents an initial reconstruction of the ground truth, where the size may be 256×256×3. In one or more embodiments, the residual may be the difference between the ground truth and reconstruction \hat{x}, whose size may be also 256×256×3. In one or more embodiments, the input to the second-step codec may also comprise one or more extra data, such as block/image resolution.

In the example embodiment of second-step codec 910 depicted in FIG. 9, the input data r is the residual between the ground truth and the initial reconstruction \hat{x} from the first-step codec 905. In one or more embodiments, h×w×3 describes the size of r, with height h, width w and number of channels 3. In one or more embodiments, the second-step codec 910 is used to code the residual information of the ground truth. In one or more embodiments, the bitstream that is output by the encoder 930 of the second-step codec represents the encoded residual information, and the output of the decoder 932 represents the reconstructed residual. In one or more embodiments, the bitstream from the first-step codec 905 and the bitstream from the second-step codec 910 represent the encoded ground truth, and the combination (for example, a sum) of initial reconstruction from first-step codec 905 and reconstructed residual from second-step codec 910 represent the final reconstructed ground truth.

In one or more embodiments, the encoder 930 of second-step codec 910 may comprise a neural encoder 934, an auxiliary encoder 944, a quantizer (not shown in FIG. 9), a probability model 942, and an entropy encoder 936. In one or more embodiments, similar to the neural encoder 916 of first-step codec 905, the neural encoder 934 of second-step codec 910 may also comprise a first convolutional layer, a non-linear activation function ReLU, a first DSA block, a second convolutional layer, a second DSA block, a third convolutional layer, a third DSA block, a fourth convolutional layer, a fourth DSA block, and a fifth convolutional layer. In one or more embodiments, the dimension of the latent tensor output by neural encoder 934 is described by h//16×w//16×128, where the height is h//16, the width is w//16, and the number of channels is 128.

In one or more embodiments, the second-step codec 910 also includes an auxiliary encoder 944 which generates auxiliary input to the probability model 942. In one or more embodiments, the auxiliary encoder 944 is used at the encoder 930 side and at decoder 932 side. In one or more embodiments, two copies of the same auxiliary encoder 944 may be created, where a first copy is used at encoder 930 side and a second copy is used at decoder 932 side. In one or more embodiments, different auxiliary encoders are used at encoder 930 side and at decoder 932 side. In one or more embodiments, the input & to the auxiliary encoder 944 is the output of first-step codec 905, which is the initial reconstruction of ground truth data. In one or more embodiments, the input \hat{x} to the auxiliary encoder 944 is a masked version of the initial reconstruction of ground truth data, which may be obtained via a masking operation performed on the initial reconstructed ground truth data. In one or more embodiments, the masking operation may mask out (e.g. setting to zero or other predetermined value) some of the elements of the initial reconstructed ground truth, such as the elements which do not exist in the residual latent tensor that is being encoded or decoded by the entropy encoder 936 or entropy decoder 940. In one or more embodiments, the input \hat{x} may be firstly input to a prediction neural network to predict the residual information, and the predicted residual information may be used as an input to the auxiliary encoder 944. In one or more embodiments, the input \hat{x} to the auxiliary encoder 944 comprises the latent tensor that is output by the entropy decoder 922 of the first-step codec 905, or the dequantized latent tensor that is output by the dequantizer of the first-step codec 905. In one or more embodiments, the auxiliary encoder 944 may have the same architecture as the neural encoder 934 of second-step codec 910. However any suitable architecture for extracting features from an image may be suitable. In one or more embodiments, the output of auxiliary encoder 944 may be input to the probability model 942 to work as extra context information. In one or more embodiments, the extra context information that is provided to the probability model 942 may comprise the latent tensor from first-step codec 905 or the dequantized latent tensor from first-step codec 905. In one or more embodiments, in a circumstance where the intra-frame codec includes separate luma codec and chroma codec, in addition to the possible auxiliary input described above, the input \hat{x} to the auxiliary encoder 944 may also comprise the reconstructed luma component, the reconstructed chroma component, or the corresponding latent tensors. In one or more embodiments where the initial reconstruction consists of sufficient information of the input data, the auxiliary input to the probability model 944 may improve the accuracy of the estimated probability density function for the elements in the quantized latent tensor that is to be encoded by the entropy encoder 936 or that is to be decoded by the entropy decoder 940. This more accurate estimation by the probability model may bring important performance gains to the coding of the residual information.

In one or more embodiments, the size of the input to the auxiliary encoder 944 may be larger than the size of the input and output of the second-step codec 910. For example, when an input image is processed in blocks, the input to the auxiliary encoder 944 may be larger than the size of a block by taking data from a larger area from the reconstructed image by the first-step codec 905.

In one or more embodiments, the input & may be used for a hyper-prior network. In one or more embodiments, the hyper-prior network is an extra compression network, which provides side information u and o as a prior information on the parameters of the entropy. In one or more embodiments, the side information u and o comprise hyperpriors. In one or more embodiments where the distribution of elements in the residual information may be similar to the distribution of elements in the initial ground-truth reconstruction, the input & relating to the initial ground-truth reconstruction may be used alone or together with the latent tensor of residual information as the input to the hyper-prior network.

In one or more embodiments, the latent tensor that is output by the encoder 930 of the second-step codec 910 (e.g., the residual latent tensor) may be input to the probability model 942. In one or more embodiments, the probability model 942 may be a neural network. In one or more embodiments, with the auxiliary input as extra context information, the probability model 942 outputs an estimate of the probability of each element of the residual latent tensor. In one or more embodiments, at encoder 930 side, the output of the probability model 942 is used as one of the inputs to an entropy encoder 936. In one or more embodiments, the entropy encoder 936 may be an arithmetic encoder. In one or more embodiments, the entropy encoder 936 takes in at least the (quantized) latent tensor and the output of the probability model 942 and outputs a bitstream that represents the encoded residual information. In one or more embodiments, the latent tensor that is input to the entropy encoder 936 is first quantized.

In one or more embodiments, the decoder 932 of second-step codec 910 may comprise an entropy decoder 940, a probability model 942, a dequantizer (not shown in the figure), an auxiliary encoder 944 and a neural decoder 938. In one or more embodiments, the entropy decoder 940 may be an arithmetic decoder. In one or more embodiments, the entropy decoder 940 takes in at least the bitstream that is output by the encoder 930 and the output of the probability model 942, and outputs a decoded (quantized) latent tensor. In one or more embodiments, the probability model 942 may need to be the same probability model that is available at encoder 930 side. In one or more embodiments, the auxiliary encoder 944 may also need to be the same auxiliary encoder 944 that is available at encoder 930 side. In one or more embodiments, the decoded (quantized) latent tensor may undergo dequantization. In one or more embodiments, after dequantization, the dequantized decoded latent tensor is input to the neural decoder 932. In one or more embodiments, the dequantized decoded latent tensor may be concatenated with the auxiliary input along the dimension of channels. In one or more embodiments, after concatenation, the new decoded latent tensor is input to the neural decoder 938. In one or more embodiments, the neural decoder 938 of second-step codec 910 may comprise a first transpose convolutional layer, a first DSA block, a second transpose convolutional layer, a second DSA block, a third transpose convolutional layer, a third DSA block, a fourth transpose convolutional layer, a fourth DSA block, a non-linear activation function ReLU, and a convolutional layer. In one or more embodiments, the output of the neural decoder 938 is a reconstruction of the residual component, and the size may be h×w×3. In one or more embodiments, the reconstructed residual is added to the initial reconstruction \hat{x}, to get the final reconstruction.

In one or more embodiments, in a first training phase, the first-step codec 905 may be trained, and in a second training phase the second-step codec 910 may be trained by taking the initial reconstruction from the first-step codec 905 as an input, where in the first training phase the second-step codec 910 is not trained and in the second training phase the first-step codec 905 is not trained. In one or more embodiments, the first-step codec 905 and the second-step codec 910 may be trained together (i.e., the second-step codec 910 takes as one of its inputs an output of the decoder 914 in the first-step codec 905 and both are trained at the same time). In one or more embodiments, the first-step codec 905 and the second-step codec 910 may be trained alternately (e.g., the first-step codec 905 is trained for a first number of iterations, then the second-step codec 910 is trained for a second number of iterations, then the first-step codec 905 is trained for a third number of iterations, then the second-step codec 910 is trained for a fourth number of iterations, and so on). A combination of these embodiments may also be possible, where, for example, in a first stage, the first-step 905 codec and the second-step codec 910 are trained in sequence (e.g., first the first-step codec 905 is trained, then the second-step codec 910 is trained), and in a second stage, the first-step codec 905 and the second-step codec 910 are jointly trained or finetuned.

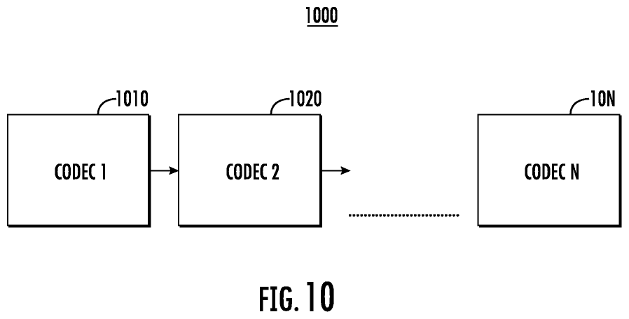

Turning now to FIG. 10, an illustration is provided of an example system 1000 where more than two codecs are used. In one or more embodiments, the e2e intra-frame learned codec may comprise n codecs, where n>=2. In one or more embodiments illustrated in FIG. 10, block 1010 represents a first-step codec, block 1020 represents a second-step codec, and the process performed by block 1020 is repeated one or more times after block 1020 culminating in block 10N representing an n-step codec. In one or more embodiments, in each codec, the auxiliary data comprises the latest reconstructed ground-truth data. In one or more embodiments, the latest reconstructed ground-truth data is derived based on an output of a decoder of the previous codec. In one or more embodiments, the latest ground-truth data is a direct output of a decoder of the previous codec. In one or more embodiments, the latest reconstructed ground-truth data is determined based on the output data obtained from the decoders of one or more previous codecs. In one or more embodiments, the latest reconstructed ground-truth data is the sum of the previous latest reconstructed ground-truth data from one or more previous codecs and the latest reconstructed residual data.

In one or more embodiments where the e2e learned codec comprises more than two steps of coding, for each of the one or more coding steps, subsequent to the first-step coding, a residual is computed based on the ground truth data and on a reconstruction that was determined based on an output of the decoder of the previous-step codec, and this residual may be input to the encoder of the current coding step. In one or more embodiments, the probability model of each codec or the auxiliary encoder of each codec may take as an input one or more of the reconstruction that was determined based on an output of the decoder of the previous-step codec, the output of the decoder of the previous-step codec, and the latent tensor determined by the previous-step codec. In one or more embodiments, the codec may comprise a first-step codec, a second-step codec, and a third-step codec.

In one or more embodiments, the input to the first-step codec is an image that represents the ground truth data. In one or more embodiments, the decoder of the first-step codec outputs a first latent tensor. In one or more embodiments, the decoder of the first-step codec outputs a first reconstructed image. In one or more embodiments, a first residual is computed as the difference between the first reconstructed image and the ground truth data.

In one or more embodiments, the first residual is input to the second-step codec. In one or more embodiments, the auxiliary encoder of the second-step codec may take as an input the first latent tensor, the first reconstructed image, features extracted from the first latent tensor, features extracted from the first reconstructed image, or the like. In one or more embodiments, the decoder of the second-step codec outputs a second latent tensor. In one or more embodiments, the decoder of the second-step codec outputs a first reconstructed residual. In one or more embodiments, the first reconstructed residual is added to the first reconstructed image to obtain a second reconstructed image. In one or more embodiments, a second residual is computed as the difference between the second reconstructed image and the ground truth.

In one or more embodiments, the second residual is input to the third-step codec. In one or more embodiments, the auxiliary encoder of the third-step codec may take as an input the second latent tensor that is determined by the second-step codec, the second reconstructed image, the first reconstructed residual, features extracted from the second latent tensor, features extracted from the second reconstructed image, features extracted from the first reconstructed residual, or the like. In one or more embodiments, the decoder of the third-step codec outputs a second reconstructed residual. In one or more embodiments, the second reconstructed residual is added to the second reconstructed image to obtain a third reconstructed image. In one or more embodiments, the third reconstructed image represents the final reconstructed image of the codec.

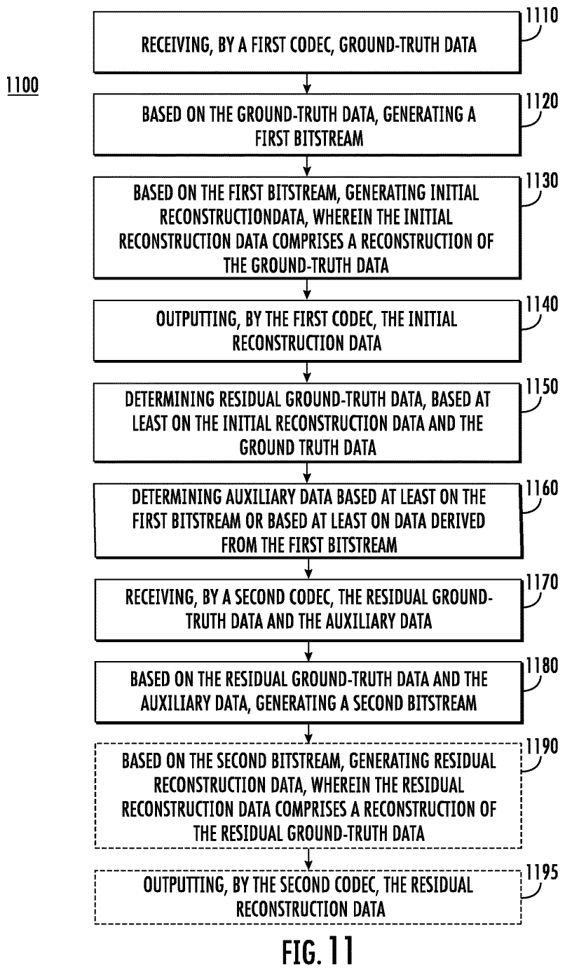

Turning now to FIG. 11, an example flowchart is illustrated for a process 1100 performed by an apparatus embodied by, associated with, or otherwise in communication with (hereinafter generally referenced as being embodied by) service device 22 to receive residual ground-truth data and auxiliary data.

As shown in block 1110 of FIG. 11, the apparatus embodied by the service device 22 includes means, such as the processor 12, the communication interface 16, or the like, for receiving, by a first codec, ground-truth data. In one or more embodiments, the ground-truth data comprises an image comprising brightness data and color data.

As shown in block 1120 of FIG. 11, the apparatus embodied by the service device 22 includes means, such as the processor 12, the communication interface 16, or the like, for, based on the ground-truth data, generating a first bitstream.

As shown in block 1130 of FIG. 11, the apparatus embodied by the service device 22 includes means, such as the processor 12, the communication interface 16, or the like, for, based on the first bitstream, generating initial reconstruction data, wherein the initial reconstruction data comprises a reconstruction of the ground-truth data.

As shown in block 1140 of FIG. 11, the apparatus embodied by the service device 22 includes means, such as the processor 12, the communication interface 16, or the like, for outputting, by the first codec, the initial reconstruction data.

As shown in block 1150 of FIG. 11, the apparatus embodied by the service device 22 includes means, such as the processor 12, the communication interface 16, or the like, for determining residual ground-truth data, based at least on the initial reconstruction data and the ground truth data. In one or more embodiments, the residual ground-truth data comprises a difference between the ground-truth data and the initial reconstruction data. In one or more embodiments, the residual ground-truth data is determined by the first codec.

As shown in block 1160 of FIG. 11, the apparatus embodied by the service device 22 includes means, such as the processor 12, the communication interface 16, or the like, for determining auxiliary data based at least on the first bitstream or based at least on data derived from the first bitstream. In one or more embodiments, the auxiliary data comprises one or more of the initial reconstruction data, the first latent tensor, and first resulting latent tensor.

As shown in block 1170 of FIG. 11, the apparatus embodied by the service device 22 includes means, such as the processor 12, the communication interface 16, or the like, for receiving, by a second codec, the residual ground-truth data and the auxiliary data. In one or more embodiments, the first codec and the second codec are trained in an end-to-end manner by decreasing at least one of distortion loss and rate loss. In one or more embodiments, the first codec is trained before the second codec, and wherein the second codec is trained based at least on the first codec or based at least on data that is generated by the first codec. In one or more embodiments, the first codec and the second codec are trained simultaneously. In one or more embodiments, the first codec and the second codec are trained at alternating intervals.

As shown in block 1180 of FIG. 11, the apparatus embodied by the service device 22 includes means, such as the processor 12, the communication interface 16, or the like, for, based on the residual ground-truth data and the auxiliary data, generating a second bitstream. In one or more embodiments, the apparatus embodied by the service device 22 includes means, such as the processor 12, the communication interface 16, or the like, for determining a combined bitstream based at least on the first bitstream and the second bitstream.

As shown in optional block 1190 of FIG. 11, the apparatus embodied by the service device 22 includes means, such as the processor 12, the communication interface 16, or the like, for, based on the second bitstream, generating residual reconstruction data, wherein the residual reconstruction data comprises a reconstruction of the residual ground-truth data. In one or more embodiments, the apparatus embodied by the service device 22 includes means, such as the processor 12, the communication interface 16, or the like, for determining combined reconstruction data based at least on the initial reconstruction data and the residual reconstruction data. In one or more embodiments, the combined reconstruction data is determined by the second codec.

As shown in optional block 1195 of FIG. 11, the apparatus embodied by the service device 22 includes means, such as the processor 12, the communication interface 16, or the like, for outputting, by the second codec, the residual reconstruction data.

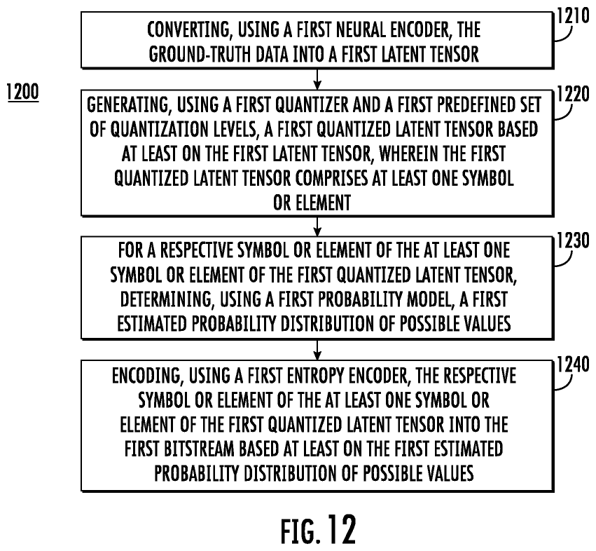

Turning now to FIG. 12, an example flowchart is illustrated for a process 1200 performed by an apparatus embodied by, associated with, or otherwise in communication with (hereinafter generally referenced as being embodied by) service device 22 to encode ground-truth data into a first bitstream.

As shown in block 1210 of FIG. 12, the apparatus embodied by the service device 22 includes means, such as the processor 12, the communication interface 16, or the like, for converting, using a first neural encoder, the ground-truth data into a first latent tensor.

As shown in block 1220 of FIG. 12, the apparatus embodied by the service device 22 includes means, such as the processor 12, the communication interface 16, or the like, for generating, using a first quantizer and a first predefined set of quantization levels, a first quantized latent tensor based at least on the first latent tensor, wherein the first quantized latent tensor comprises at least one symbol or element.

As shown in block 1230 of FIG. 12, the apparatus embodied by the service device 22 includes means, such as the processor 12, the communication interface 16, or the like, for, for a respective symbol or element of the at least one symbol or element of the first quantized latent tensor, determining, using a first probability model, a first estimated probability distribution of possible values.

As shown in block 1240 of FIG. 12, the apparatus embodied by the service device 22 includes means, such as the processor 12, the communication interface 16, or the like, for encoding, using a first entropy encoder, the respective symbol or element of the at least one symbol or element of the first quantized latent tensor into the first bitstream based at least on the first estimated probability distribution of possible values

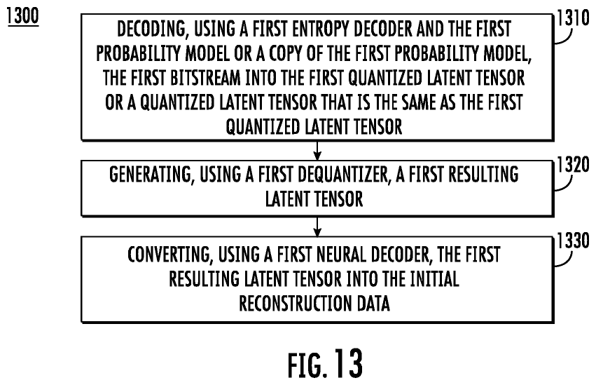

Turning now to FIG. 13, an example flowchart is illustrated for a process 1300 performed by an apparatus embodied by, associated with, or otherwise in communication with (hereinafter generally referenced as being embodied by) service device 22 to decode a first bitstream into initial reconstruction data.

As shown in block 1310 of FIG. 13, the apparatus embodied by the service device 22 includes means, such as the processor 12, the communication interface 16, or the like, for decoding, using a first entropy decoder and the first probability model or a copy of the first probability model, the first bitstream into the first quantized latent tensor or a quantized latent tensor that is the same as the first quantized latent tensor.

As shown in block 1320 of FIG. 13, the apparatus embodied by the service device 22 includes means, such as the processor 12, the communication interface 16, or the like, for generating, using a first dequantizer, a first resulting latent tensor.

As shown in block 1330 of FIG. 13, the apparatus embodied by the service device 22 includes means, such as the processor 12, the communication interface 16, or the like, for converting, using a first neural decoder, the first resulting latent tensor into the initial reconstruction data.

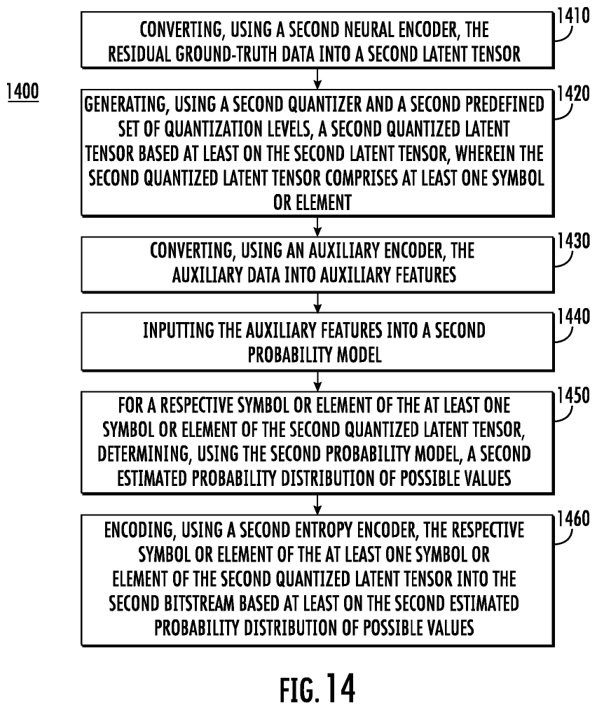

Turning now to FIG. 14, an example flowchart is illustrated for a process 1400 performed by an apparatus embodied by, associated with, or otherwise in communication with (hereinafter generally referenced as being embodied by) service device 22 to encode residual ground-truth data into a second bitstream.

As shown in block 1410 of FIG. 14, the apparatus embodied by the service device 22 includes means, such as the processor 12, the communication interface 16, or the like, for converting, using a second neural encoder, the residual ground-truth data into a second latent tensor.

As shown in block 1420 of FIG. 14, the apparatus embodied by the service device 22 includes means, such as the processor 12, the communication interface 16, or the like, for generating, using a second quantizer and a second predefined set of quantization levels, a second quantized latent tensor based at least on the second latent tensor, wherein the second quantized latent tensor comprises at least one symbol or element.

As shown in block 1430 of FIG. 14, the apparatus embodied by the service device 22 includes means, such as the processor 12, the communication interface 16, or the like, for converting, using an auxiliary encoder, the auxiliary data into auxiliary features.

As shown in block 1440 of FIG. 14, the apparatus embodied by the service device 22 includes means, such as the processor 12, the communication interface 16, or the like, for inputting the auxiliary features into a second probability model.

As shown in block 1450 of FIG. 14, the apparatus embodied by the service device 22 includes means, such as the processor 12, the communication interface 16, or the like, for, for a respective symbol or element of the at least one symbol or element of the second quantized latent tensor, determining, using the second probability model, a second estimated probability distribution of possible values.

As shown in block 1460 of FIG. 14, the apparatus embodied by the service device 22 includes means, such as the processor 12, the communication interface 16, or the like, for encoding, using a second entropy encoder, the respective symbol or element of the at least one symbol or element of the second quantized latent tensor into the second bitstream based at least on the second estimated probability distribution of possible values.

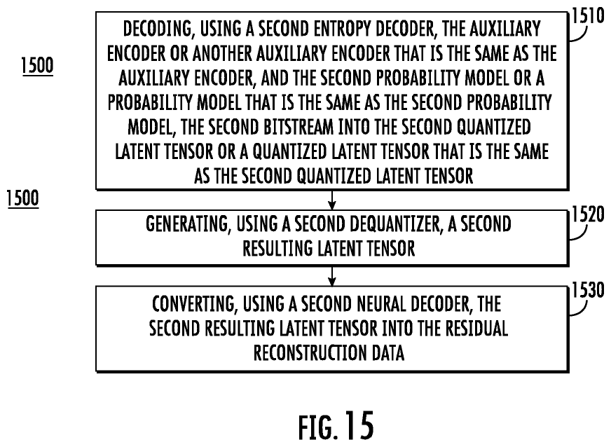

Turning now to FIG. 15, an example flowchart is illustrated for a process 1500 performed by an apparatus embodied by, associated with, or otherwise in communication with (hereinafter generally referenced as being embodied by) service device 22 to decode a second bitstream into residual reconstruction data.

As shown in block 1510 of FIG. 15, the apparatus embodied by the service device 22 includes means, such as the processor 12, the communication interface 16, or the like, for decoding, using a second entropy decoder, the auxiliary encoder or another auxiliary encoder that is the same as the auxiliary encoder, and the second probability model or another probability model that is the same as the second probability model, the second bitstream into the second quantized latent tensor or a quantized latent tensor that is the same as the second quantized latent tensor.

As shown in block 1520 of FIG. 15, the apparatus embodied by the service device 22 includes means, such as the processor 12, the communication interface 16, or the like, for generating, using a second dequantizer, a second resulting latent tensor.

As shown in block 1530 of FIG. 15, the apparatus embodied by the service device 22 includes means, such as the processor 12, the communication interface 16, or the like, for converting, using a second neural decoder, the second resulting latent tensor into the residual reconstruction data. In one or more embodiments, at least one of the first neural encoder, the first neural decoder, the first probability model, the second neural encoder, the second neural decoder, the second probability model, and the auxiliary encoder comprise neural network components.

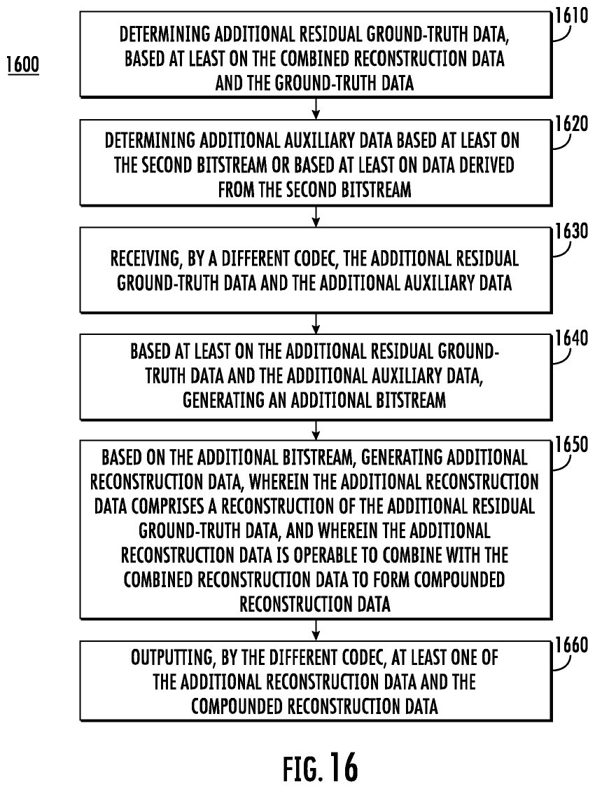

Turning now to FIG. 16, an example flowchart is illustrated for a process 1600 performed by an apparatus embodied by, associated with, or otherwise in communication with (hereinafter generally referenced as being embodied by) service device 22 to output additional reconstruction data.

As shown in block 1610 of FIG. 16, the apparatus embodied by the service device 22 includes means, such as the processor 12, the communication interface 16, or the like, for determining additional residual ground-truth data, based at least on the combined reconstruction data and the ground-truth data.

As shown in block 1620 of FIG. 16, the apparatus embodied by the service device 22 includes means, such as the processor 12, the communication interface 16, or the like, for determining additional auxiliary data based at least on the second bitstream or based at least on data derived from the second bitstream.

As shown in block 1630 of FIG. 16, the apparatus embodied by the service device 22 includes means, such as the processor 12, the communication interface 16, or the like, for receiving, by a different codec, the additional residual ground-truth data and the additional auxiliary data.

As shown in block 1640 of FIG. 16, the apparatus embodied by the service device 22 includes means, such as the processor 12, the communication interface 16, or the like, for, based at least on the additional residual ground-truth data and the additional auxiliary data, generating an additional bitstream.

As shown in block 1650 of FIG. 16, the apparatus embodied by the service device 22 includes means, such as the processor 12, the communication interface 16, or the like, for, based at least on the additional bitstream, generating additional reconstruction data, wherein the additional reconstruction data comprises a reconstruction of the additional residual ground-truth data, and wherein the additional reconstruction data is operable to combine with the combined reconstruction data to form compounded reconstruction data.

As shown in block 1660 of FIG. 16, the apparatus embodied by the service device 22 includes means, such as the processor 12, the communication interface 16, or the like, for outputting, by the different codec, at least one of the additional reconstruction data and the compounded reconstruction data.

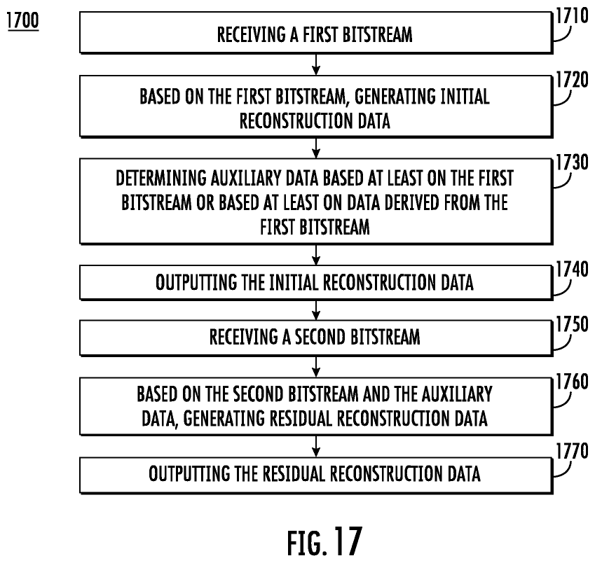

Turning now to FIG. 17, an example flowchart is illustrated for a process 1700 performed by an apparatus embodied by, associated with, or otherwise in communication with (hereinafter generally referenced as being embodied by) consumer device 24 to decode bitstreams into reconstruction data.

As shown in block 1710 of FIG. 17, the apparatus embodied by the consumer device 24 includes means, such as the processor 12, the communication interface 16, or the like, for receiving a first bitstream.

As shown in block 1720 of FIG. 17, the apparatus embodied by the consumer device 24 includes means, such as the processor 12, the communication interface 16, or the like, for, based on the first bitstream, generating initial reconstruction data.

As shown in block 1730 of FIG. 17, the apparatus embodied by the consumer device 24 includes means, such as the processor 12, the communication interface 16, or the like, for determining auxiliary data based at least on the first bitstream or based at least on data derived from the first bitstream.

As shown in block 1740 of FIG. 17, the apparatus embodied by the consumer device 24 includes means, such as the processor 12, the communication interface 16, or the like, for outputting the initial reconstruction data.

As shown in block 1750 of FIG. 17, the apparatus embodied by the consumer device 24 includes means, such as the processor 12, the communication interface 16, or the like, for receiving a second bitstream. In one or more embodiments, the first bitstream and the second bitstream are received as parts of a combined bitstream.

As shown in block 1760 of FIG. 17, the apparatus embodied by the consumer device 24 includes means, such as the processor 12, the communication interface 16, or the like, for, based on the second bitstream and the auxiliary data, generating residual reconstruction data.

As shown in block 1770 of FIG. 17, the apparatus embodied by the consumer device 24 includes means, such as the processor 12, the communication interface 16, or the like, for outputting the residual reconstruction data. In one or more embodiments, the apparatus embodied by the consumer device 24 includes means, such as the processor 12, the communication interface 16, or the like, for determining combined reconstruction data based at least on the initial reconstruction data and the residual reconstruction data. In one or more embodiments, the apparatus embodied by the consumer device 24 includes means, such as the processor 12, the communication interface 16, or the like, for

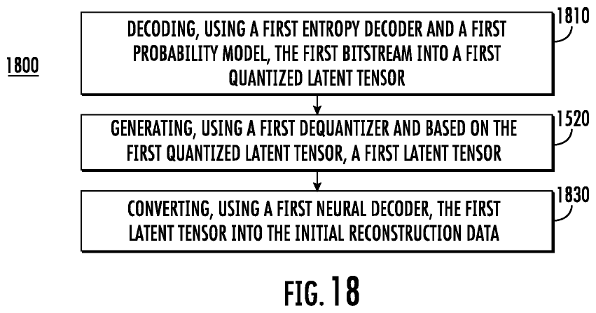

Turning now to FIG. 18, an example flowchart is illustrated for a process 1800 performed by an apparatus embodied by, associated with, or otherwise in communication with (hereinafter generally referenced as being embodied by) consumer device 24 to decode a first bitstream into initial reconstruction data.

As shown in block 1810 of FIG. 18, the apparatus embodied by the consumer device 24 includes means, such as the processor 12, the communication interface 16, or the like, for decoding, using a first entropy decoder and a first probability model, the first bitstream into a first quantized latent tensor.

As shown in block 1820 of FIG. 18, the apparatus embodied by the consumer device 24 includes means, such as the processor 12, the communication interface 16, or the like, for generating, using a first dequantizer and based on the first quantized latent tensor, a first latent tensor.

As shown in block 1830 of FIG. 18, the apparatus embodied by the consumer device 24 includes means, such as the processor 12, the communication interface 16, or the like, for converting, using a first neural decoder, the first latent tensor into the initial reconstruction data.

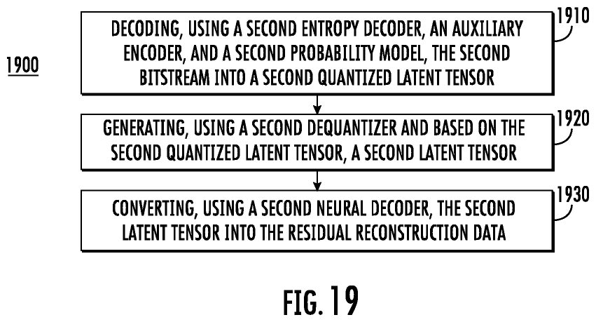

Turning now to FIG. 19, an example flowchart is illustrated for a process 1900 performed by an apparatus embodied by, associated with, or otherwise in communication with (hereinafter generally referenced as being embodied by) consumer device 24 to decode a second bitstream into residual reconstruction data.

As shown in block 1910 of FIG. 19, the apparatus embodied by the consumer device 24 includes means, such as the processor 12, the communication interface 16, or the like, for decoding, using a second entropy decoder, an auxiliary encoder, and a second probability model, the second bitstream into a second quantized latent tensor.

As shown in block 1920 of FIG. 19, the apparatus embodied by the consumer device 24 includes means, such as the processor 12, the communication interface 16, or the like, for generating, using a second dequantizer and based on the second quantized latent tensor, a second latent tensor.

As shown in block 1930 of FIG. 19, the apparatus embodied by the consumer device 24 includes means, such as the processor 12, the communication interface 16, or the like, for converting, using a second neural decoder, the second latent tensor into the residual reconstruction data. In one or more embodiments, at least one of the first neural decoder, the first probability model, the second neural decoder, and the second probability model comprise neural network components.

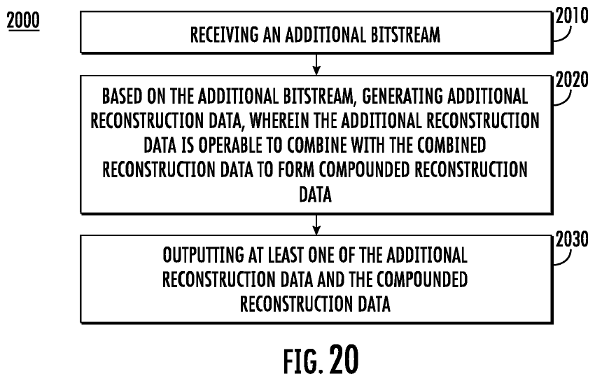

Turning now to FIG. 20, an example flowchart is illustrated for a process 2000 performed by an apparatus embodied by, associated with, or otherwise in communication with (hereinafter generally referenced as being embodied by) consumer device 24 to decode a an additional bitstream into additional reconstruction data.

As shown in block 2010 of FIG. 20, the apparatus embodied by the consumer device 24 includes means, such as the processor 12, the communication interface 16, or the like, for receiving an additional bitstream.

As shown in block 2020 of FIG. 20, the apparatus embodied by the consumer device 24 includes means, such as the processor 12, the communication interface 16, or the like, for, based on the additional bitstream, generating additional reconstruction data, wherein the additional reconstruction data is operable to combine with the combined reconstruction data to form compounded reconstruction data.

As shown in block 2030 of FIG. 20, the apparatus embodied by the consumer device 24 includes means, such as the processor 12, the communication interface 16, or the like, for outputting at least one of the additional reconstruction data and the compounded reconstruction data.

FIGS. 11-20 illustrate flowcharts depicting methods according to an example embodiment of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus employing an embodiment and executed by a processor 12. As will be appreciated, any such computer program instructions may be loaded into a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded into a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A computer-implemented method, comprising:
receiving, by a first codec, ground-truth data;
based on the ground-truth data, generating a first bitstream;
based on the first bitstream, generating initial reconstruction data, wherein the initial reconstruction data comprises a reconstruction of the ground-truth data;
outputting, by the first codec, the initial reconstruction data;
determining residual ground-truth data based at least on the initial reconstruction data and the ground-truth data;
determining auxiliary data based at least on the first bitstream or based at least on data derived from the first bitstream;
receiving, by a second codec, the residual ground-truth data and the auxiliary data; and
based on the residual ground-truth data and the auxiliary data, generating a second bitstream.

2. The computer-implemented method of claim 1, further comprising:
based on the second bitstream, generating residual reconstruction data, wherein the residual reconstruction data comprises a reconstruction of the residual ground-truth data; and
outputting, by the second codec, the residual reconstruction data.

3. The computer-implemented method of claim 1, further comprising:
determining combined reconstruction data based at least on the initial reconstruction data and the residual reconstruction data.

4. The computer-implemented method of any one of claim 1, further comprising:
determining a combined bitstream based at least on the first bitstream and the second bitstream.

5. The computer-implemented method of claim 1, wherein the residual ground-truth data comprises a difference between the ground-truth data and the initial reconstruction data.

6. The computer-implemented method of claim 1, wherein the ground-truth data comprises an image comprising brightness data and color data.

7. The computer-implemented method of claim 1, wherein generating the first bitstream comprises:
converting, using a first neural encoder, the ground-truth data into a first latent tensor;
generating, using a first quantizer and a first predefined set of quantization levels, a first quantized latent tensor based at least on the first latent tensor, wherein the first quantized latent tensor comprises at least one symbol or element;
for a respective symbol or element of the at least one symbol or element of the first quantized latent tensor, determining, using a first probability model, a first estimated probability distribution of possible values; and
encoding, using a first entropy encoder, the respective symbol or element of the at least one symbol or element of the first quantized latent tensor into the first bitstream based at least on the first estimated probability distribution of possible values.

8. The computer-implemented method of claim 1, wherein generating the initial reconstruction data comprises:
decoding, using a first entropy decoder and the first probability model or a copy of the first probability model, the first bitstream into the first quantized latent tensor or a quantized latent tensor that is the same as the first quantized latent tensor;
generating, using a first dequantizer, a first resulting latent tensor; and
converting, using a first neural decoder, the first resulting latent tensor into the initial reconstruction data.

9. The computer-implemented method of claim 1, wherein generating the second bitstream comprises:
converting, using a second neural encoder, the residual ground-truth data into a second latent tensor;
generating, using a second quantizer and a second predefined set of quantization levels, a second quantized latent tensor based at least on the second latent tensor, wherein the second quantized latent tensor comprises at least one symbol or element;
converting, using an auxiliary encoder, the auxiliary data into auxiliary features;
inputting the auxiliary features into a second probability model;
for a respective symbol or element of the at least one symbol or element of the second quantized latent tensor, determining, using the second probability model, a second estimated probability distribution of possible values; and
encoding, using a second entropy encoder, the respective symbol or element of the at least one symbol or element of the second quantized latent tensor into the second bitstream based at least on the second estimated probability distribution of possible values.

10. The computer-implemented method of claim 1, wherein generating the residual reconstruction data comprises:
decoding, using a second entropy decoder, the auxiliary encoder or another auxiliary encoder that is the same as the auxiliary encoder, and the second probability model or another probability model that is the same as the second probability model, the second bitstream into the second quantized latent tensor or a quantized latent tensor that is the same as the second quantized latent tensor;
generating, using a second dequantizer, a second resulting latent tensor; and
converting, using a second neural decoder, the second resulting latent tensor into the residual reconstruction data.

11. The computer-implemented method of claim 7, wherein at least one of the first neural encoder, the first neural decoder, the first probability model, the second neural encoder, the second neural decoder, the second probability model, and the auxiliary encoder comprise neural network components.

12. The computer-implemented method of claim 1, wherein the first codec and the second codec are trained in an end-to-end manner by decreasing at least one of distortion loss and rate loss.

13. The computer-implemented method of claim 12, wherein the first codec is trained before the second codec, and wherein the second codec is trained based at least on the first codec or based at least on data that is generated by the first codec.

14. The computer-implemented method of claim 12, wherein the first codec and the second codec are trained simultaneously.

15. The computer-implemented method of claim 12, wherein the first codec and the second codec are trained at alternating intervals.

16. The computer-implemented method of claim 1, wherein the auxiliary data comprises one or more of the initial reconstruction data, the first latent tensor, and the first resulting latent tensor.

17. The computer-implemented method of claim 1, wherein the residual ground-truth data is determined by the first codec.

18. The computer-implemented method of claim 3, wherein the combined reconstruction data is determined by the second codec.

19. The computer-implemented method of claim 3, further comprising:
determining additional residual ground-truth data, based at least on the combined reconstruction data and the ground-truth data;
determining additional auxiliary data based at least on the second bitstream or based at least on data derived from the second bitstream;
receiving, by a different codec, the additional residual ground-truth data and the additional auxiliary data;
based at least on the additional residual ground-truth data and the additional auxiliary data, generating an additional bitstream;
based on the additional bitstream, generating additional reconstruction data, wherein the additional reconstruction data comprises a reconstruction of the additional residual ground-truth data, and wherein the additional reconstruction data is operable to combine with the combined reconstruction data to form compounded reconstruction data; and
outputting, by the different codec, at least one of the additional reconstruction data and the compounded reconstruction data.

20-26. (canceled)

27. An apparatus, comprising:
at least one processor; and
at least one memory storing instructions that, when executed by the at least one processor, cause the apparatus to at least perform;
receive, by a first codec, ground-truth data;
based on the ground-truth data, generate a first bitstream;
based on the first bitstream, generate initial reconstruction data, wherein the initial reconstruction data comprises a reconstruction of the ground-truth data;
output, by the first codec, the initial reconstruction data;
determine residual ground-truth data based at least on the initial reconstruction data and the ground-truth data;
determine auxiliary data based at least on the first bitstream or based at least on data derived from the first bitstream;
receive, by a second codec, the residual ground-truth data and the auxiliary data; and
based on the residual ground-truth data and the auxiliary data, generate a second bitstream.

28. The apparatus of claim 27, wherein the at least one memory and the computer program code are further configured to, with the at least one processor, cause the apparatus to:
based on the second bitstream, generate residual reconstruction data, wherein the residual reconstruction data comprises a reconstruction of the residual ground-truth data; and
output, by the second codec, the residual reconstruction data.

29. The apparatus of claim 27, wherein the at least one memory and the computer program code are further configured to, with the at least one processor, cause the apparatus to:
determine combined reconstruction data based at least on the initial reconstruction data and the residual reconstruction data.

30. The apparatus of claim 27, wherein the at least one memory and the computer program code are further configured to, with the at least one processor, cause the apparatus to:
determine a combined bitstream based at least on the first bitstream and the second bitstream.

31. The apparatus of claim 27, wherein the residual ground-truth data comprises a difference between the ground-truth data and the initial reconstruction data.

32-52. (canceled)

53. A non-transitory computer readable storage medium comprising computer instructions that, when executed by an apparatus, cause the apparatus to perform a method comprising:
receiving, by a first codec, ground-truth data;
based on the ground-truth data, generating a first bitstream;
based on the first bitstream, generating initial reconstruction data, wherein the initial reconstruction data comprises a reconstruction of the ground-truth data;
outputting, by the first codec, the initial reconstruction data;
determining residual ground-truth data based at least on the initial reconstruction data and the ground-truth data;
determining auxiliary data based at least on the first bitstream or based at least on data derived from the first bitstream;
receiving, by a second codec, the residual ground-truth data and the auxiliary data; and
based on the residual ground-truth data and the auxiliary data, generating a second bitstream.

54-80. (canceled)
